(19) United States
(12) Patent Application Publication
(10) Pub. No.: US 2004/0025974 A1
(43) Pub. Date: Feb. 12, 2004

(54) Nanocrystalline and nanocomposite rare earth permanent magnet materials and method of making the same

(76) Inventors: Don Lee, Miamisburg, OH (US); John Stanley Hilton, Beavercreek, OH (US); Baozhi Cui, Kettering, OH (US); Shiqiang Liu, Springboro, OH (US)

Correspondence Address: Killworth, Gottman, Hagan & Schaeff, L.L.P., One Dayton Center, Suite 500, Dayton, OH, 45402-2023, US

(21) Appl. No.: 10/397,713

(22) Filed: Mar. 26, 2003

Related U.S. Application Data
(60) Provisional application No. 60/382,936, filed on May 24, 2002.
(60) Provisional application No. 60/437,791, filed on Jan. 3, 2003.

(51) Int. Cl. H01F 1/055

(52) U.S. Cl. 148/301

(57) ABSTRACT

Nanocrystalline and nanocomposite rare earth permanent magnet materials and methods for making the magnets are provided. The magnet materials can be isotropic or anisotropic and do not have a rare-earth rich phase. The magnet materials comprise nanometer scale grains and possesses a potential high maximum energy product, a high remancence, and a high intrinsic coercivity. The magnet materials having these properties are produced by using methods including magnetic annealing and rapid heat processing.

### BACKGROUND

The present invention relates to rare earth permanent magnet materials, and more particularly, the present invention relates to isotropic and anisotropic, nanocrystalline and nanocomposite rare earth permanent magnet materials and a method of making the magnet materials.

The current isotropic nanocomposite rare earth magnet materials have a low remanence, poor squareness of the demagnetization curve, and low maximum energy products. Isotropic nanocomposite magnets are available currently in the form of powders or ribbons. The powders or ribbons can be made into a bonded magnetic material, however, a 40-50% reduction in magnetic performance is experienced.

Therefore, there is a need in the art for not only isotropic, but also anisotropic, nanocrystalline and nanocomposite rare earth permanent magnet materials that have a higher remanence, good squareness of the demagneitzation curve, and higher maximum energy products. In addition, there is a need for nanocrystalline and nanocomposite rare earth permanent magnet materials having a high magnetic performance not only in the form of ribbons, powders, and bonded magnets, but also as bulk magnet materials. Furthermore, there is a need to produce low-cost nanocrystalline and nanocomposite rare earth permanent magnet materials.

### SUMMARY OF THE INVENTION

These needs are met by the present invention which provides rare earth permanent magnet material compositions that can be either nanocomposite or nanocrystallized that have a high remanence (Bᵣ), good squareness of the demangetization curve, and high maximum energy products (BH₍ₘₐₓ₎). The magnet materials do not contain a rare-earth rich phase. The magnet materials can be isotropic or anisotropic and can be in the form of powder particles, flasks, ribbons, bonded magnets, or bulk magnets. The magnet materials having these properties are produced by using methods including magnetic annealing and rapid heat processing.

In one embodiment, a rare earth permanent magnet material is provided comprising an average grain size between about 1 nm and about 400 nm and a composition comprising at least one rare-earth and at least one transition metal. The at least one rare-earth and the at least one transition metal form a chemical compound. The at least one rare-earth is present in the magnet in an amount that is equal to or lower than the chemical stoichiometric amount of the rare-earth in the chemical compound. The magnet material comprises full density and is selected from a bulk isotropic structure or a bulk anisotropic structure. Also, the magnet material is selected from a nanocrystalline rare earth magnet or a nanocomposite rare earth magnet.

Furthermore, the magnet material can comprise a composition having a formula specified in atomic percentage selected from RₓT_{100-x-y-z}M_{y}L_{z}. R is selected from at least one rare earth material, yttrium, and combinations thereof; T is selected from at least one transition metal and a combination of transition metals; M is selected from at least one element in group IIIA, at least one element in group IVA, at least one element in group VA, and combinations thereof; L is one or a mixture of metals or alloys having a melting temperature not higher than 950° C.; x is between about 2 to about 16.7; y is between about 0 to about 20; and z is between about 0 to about 16.

In another embodiment a rare earth permanent magnet material is provided comprising an average grain size between about 1 nm and about 400 nm and a composition comprising at least one rare-earth and at least one transition metal. The at least one rare-earth and the at least one transition metal form a chemical compound. The at least one rare-earth is present in said magnet in an amount that is equal to or lower than the chemical stoichiometric amount of said rare-earth in the chemical compound. The magnet material comprises an anisotropic structure and is selected from nanocrystalline rare earth magnet powders or a nanocomposite rare earth magnet powders.

Furthermore, the magnet material can comprise a composition having a formula specified in atomic percentage selected from RₓT_{100-x-y-z}M_{y}L_{z}. R is selected from at least one rare earth material, yttrium, and combinations thereof; T is selected from at least one transition metal and a combination of transition metals; M is selected from at least one element in group IIIA, at least one element in group IVA, at least one element in group VA, and combinations thereof; L is one or a mixture of metals or alloys having a melting temperature not higher than 950° C.; x is between about 2 to about 16.7; y is between about 0 to about 20; and z is between about 0 to about 16.

In another embodiment, a method of fabricating a magnet material is provided comprising providing at least one rare earth-transition metal alloy having no rare-earth rich phase; placing the at least one alloy in a powder form; compacting the powder form at a temperature lower than the crystallization temperature of the alloy to form compacts; rapidly pressing the powder or powder compacts at elevated temperature using a direct heating selected from DC, pulse DC, AC current, or eddy-current; and forming a bulk magnet having density close or equal to the theoretical density value. The method may further comprise mixing an additive with the at least one alloy before placing the at least one alloy in said powder form. The method may further comprise blending at least two alloy powders together before compacting powder form. The method may further comprise crystallizing said compacts using an elastic stress before rapidly pressing the compacts. The method may further comprise crystallizing the compact in a magnetic field before rapidly pressing the compacts. The method may further comprise crushing the magnet after said rapidly pressing the powder.

In yet another embodiment, a method of fabricating a magnet material is provided comprising providing at least one rare earth-transition metal alloy having no rare-earth rich phase; placing the at least one alloy in a powder form; compacting the powder form at a temperature lower than the crystallization temperature of the alloy to form compacts; hot deforming the compacts or the bulk magnet using a pressure between about 2 kpsi and about 10 kpsi; and forming an anisotropic magnet having a maximum magnetic energy product of at least 25 MGOe. The method may further comprise crushing the magnet after the hot deforming the compacts or magnets. The method may further comprise adding a binder to said powder form before compacting the powder form.

These and other features and advantages of the invention will be more fully understood from the following description of the invention taken together with the accompanying drawings. It is noted that the scope of the claims is defined by the recitations therein and not by the specific discussion of features and advantages set forth in the present description.

### BRIEF DESCRIPTION OF THE DRAWINGS

FIG. 1 is a flow chart of the processes used to fabricate isotropic and anisotropic nanocrystalline and nanocomposite rare earth permanent magnet materials.

FIG. 2 is a graph showing the temperature dependence of specific magnetization for Nd_{2.4}Pr_{5.6}Dy₁Fe₈₅B₆ in a 10 kOe DC magnetic field.

FIG. 3 is a graph showing the effect of magnetic annealing on intrinsic coercivity Nd_{2.4}Pr_{5.6}Dy₁Fe₈₅B₆.

FIG. 4 is a graph showing the effect of magnetic annealing on remanence of Nd_{2.4}Pr_{5.6}Dy₁Fe₈₅B₆.

FIG. 5 is a graph showing the effect of magnetic annealing on maximum energy product of Nd_{2.4}Pr_{5.6}Dy₁Fe₈₅B₆.

FIG. 6 is a graph showing the effect of magnetic annealing on demagnetization curves of Nd_{2.4}Pr_{5.6}Dy₁Fe₈₅B₆.

FIG. 7 is a graph showing the effect of the strength of the applied magnetic field in magnetic annealing on magnetic properties of Nd_{2.4}Pr_{5.6}Dy₁Fe₈₅B₆ annealed at 660° C. for 30 sec.

FIG. 8 is a graph showing demagnetization curves of a nanocomposite SmCo_{9.5} magnet annealed at 750° C. with or without magnetic field.

FIG. 9 is a graph showing demagnetization curves of nanocomposite (100-x) wt % YCo₅+x wt % α-Fe alloys annealed at 750° C. for 2 minutes.

FIG. 10 is a graph showing demagnetization curves of a mechanically alloyed 90 wt % YCo_{4.5}+10 wt % α-Fe alloy annealed at 660° C. and 750° C. for 2 minutes, respectively.

FIG. 11 is a graph showing demagnetization curves of nanocomposite Y₁₀Fe_{83.1}Cr_{0.9}B₆ and Y₁₀Fe₇₈Cr₆B₆ annealed at 660° C. for 2 min.

FIG. 12 is a graph showing the dependence of density for hot pressed magnet on rare earth content.

FIG. 13 is a graph showing the dependence of intrinsic coercivity on hot pressed temperature.

FIG. 14 is a graph showing the magnetic properties versus hot press pressure.

FIG. 15 is a graph showing the demagnetization curves of hot-pressed isotropic Nd_{2.2}Pr_{2.8}Dy₁Fe₈₃Co₅B₆.

FIG. 16 is a graph showing the demagnetization curves of hot-pressed isotropic Nd₈Pr_{1.4}Dy_{0.5}Fe_{78.3}Co_{5.9}Ga_{0.1}B_{5.8}.

FIG. 17 is a graph showing the demagnetization curves of hot-pressed isotropic Nd_{11.8}Fe_{77.2}Co_{5.5}B_{5.5}.

FIG. 18 is a graph showing the demagnetization curves of hot pressed and hot deformed Nd_{10.7}Pr_{0.7}Dy_{0.2}Fe_{76.1}Co_{6.3}Ga_{0.4}B_{5.6}.

FIG. 19 is a graph showing the demagnetization curves of hot pressed and hot deformed Nd_{10.3}Pr_{0.8}Dy_{0.3}B_{5.9}Co_{3.6}Fe_{79.1} magnet.

FIG. 20 is a graph showing the demagnetization curves of hot pressed and hot deformed Nd_{9.7}Pr₁Dy_{0.3}B_{5.7}Co_{6.1}Ga_{0.3}Fe_{76.9} magnet.

FIG. 21 is a graph showing the demagnetization curves and magnetic properties of hot-pressed and hot-deformed magnet specimen of Nd_{9.2}Pr₁Dy_{0.3}Fe_{77.3}Co_{6.1}Al_{0.2}Ga_{0.2}B_{5.7}.

FIG. 22 is a graph showing the demagnetization curves of a nanocomposite Nd_{10.8}Pr_{0.6}Dy_{0.2}Fe_{76.1}Co_{6.3}Ga_{0.2}Al_{0.2}B_{5.6} hot pressed at deformed at 820° C. using blending powder method.

FIG. 23 is a graph showing the demagnetization curves of a nanocomposite Nd_{10.8}Pr_{0.6}Dy_{0.2}Fe_{76.1}Co_{6.3}Ga_{0.2}A_{10.2}B_{5.6} hot pressed at 920° C. using blending powder method

FIG. 24 is a graph showing the demagnetization curves characterized along the easy and difficult magnetization directions of Nd_{10.5}Pr_{0.8}Dy_{0.3}Fe_{78.9}Co_{3.6}B_{5.9}.

FIG. 25 is a graph showing the induction demagnetization curve of Nd_{9.2}Pr₁Dy_{0.3}Fe_{77.3}Co_{6.1}Ga_{0.2}Al_{0.2}B_{5.7} showing recoil permeability.

FIG. 26 is a graph showing the variation of magnetization at 10 kOe vs. temperature for Nd_{9.3}Pr₁Dy_{0.3}Fe_{77.5}Co_{6.1}Ga_{0.2}B_{5.7}.

FIG. 27a is a photomicrograph of the fracture surface of hot-deformed Nd_{9.3}Pr₁Dy_{0.3}Fe_{77.4}Co_{6.1}Ga_{0.2}B_{5.7}.

FIG. 27b is a photomicrograph of the fracture surface of hot-deformed Nd_{9.3}Pr₁Dy_{0.3}Fe_{77.4}Co_{6.1}Ga_{0.2}B_{5.7}.

FIG. 28 is a photomicrograph of a selected area electron diffraction pattern of hot-deformed Nd_{9.3}Pr₁Dy_{0.3}Fe_{77.4}Co_{6.1}Ga_{0.2}B_{5.7}.

FIG. 29 is a photomicrograph of a selected area electron diffraction pattern of a hot-pressed Nd_{2.4}Pr_{5.6}Dy₁Fe₈₅B₆.

FIG. 30a is a graph showing the effect of amount of hot deformation on 4πM at 10 kOe of Nd_{10.4}Pr₁Dy_{0.3}Fe_{76.1}Co_{6.1}Ga_{0.2}Al_{0.2}B_{5.7}.

FIG. 30b is a graph showing the effect of amount of hot deformation on remanence of Nd_{10.4}Pr₁Dy_{0.3}Fe_{76.1}Co_{6.1}Ga_{0.2}Al_{0.2}B_{5.7}.

FIG. 30c is a graph showing the effect of amount of hot deformation on ratio of Br/4πM at 10 kOe of Nd_{10.4}Pr₁Dy_{0.3}Fe_{76.1}Co_{6.1}Ga_{0.2}Al_{0.2}B_{5.7}.

### DETAILED DESCRIPTION

The present invention provides rare earth permanent magnets that can be either nanocrystalline or nanocomposite and do not contain a rare-earth rich phase. The magnets can be isotropic or anisotropic. The magnets comprise nanometer scale grains and possesses a potential high maximum energy product (BH(max)), a high remanence (Bᵣ), and a high intrinsic coercivity. The magnets having these properties are produced by using methods including magnetic annealing and rapid heat processing.

By “nanocrystalline,” it is meant that the nanocrystalline rare earth permanent magnets are nanograin magnets with the rare earth content to be about the same as that in the chemical stoichiometry of rare earth-transition metal compounds. Therefore, the magnets essentially do not contain a rare earth-rich phase nor a magnetically soft phase. By “nanocomposite,” it is meant that the nanocomposite rare earth permanent magnets are nanograin magnets with the rare earth content to be lower than that in the chemical stoichiometry of rare earth-transition metal compounds. Therefore, there exist magnetically hard and soft phases in the nanocomposite rare earth permanent magnet materials.

More specifically, in one embodiment, the content of the rare-earth is less than the chemical stoichiometry of the rare earth-transition metal compounds. In another embodiment, the average content of the rare earth material present in the compositions is less than the chemical stoichiometry of the rare earth-transition metal compounds. This is explained further below. The average grain size of the materials used in the composition is between about 1 nanometer to about 400 nanometers, and more specifically, between about 3 nanometers to about 300 nanometers.

The magnets may comprise a composition having a general formula specified in the atomic percentage as RₓT_{100-x-y-z}M_{y}L_{z}. R is selected from at least one rare earth, yttrium, and combinations thereof. The at least one rare earth can be selected from Nd, Sm, Pr, Dy, La, Ce, Gd, Tb, Ho, Er, Eu, Tm, Yb, Lu, MM (misch metal),Y, and combinations thereof. T is selected from at least one transition metal and a combination of transition metals. The transition metal include, but are not limited to, Fe, Co, Ni, Ti, Zr, Hf. V, Nb, Ta, Cr, Mo, W, Mn, Cu, Zn, and Cd. M is selected from at least one element in group IIIA, at least one element in group IVA, at least one element in group VA, and combinations thereof. The elements include, but are not limited to, B, Al, Ga, In Ti, C, Si, Ge, Sn, Sb, and Bi. L is one or a mixture of metals or alloys having a melting temperature not higher than 950° C.

The value of x is approximately equal to or lower than the rare earth content in the chemical stoichiometry of the corresponding rare earth-transition metal compound that the magnet material is based upon. Typically, x is between about 2 and about 16.7. Typically, y is between about 0 and about 25. Typically, z is between about 0 and about 16. It is to be appreciated that if y is equal to zero, then there will be no amount of M in the composition. Similarly, if z is equal to zero, then there will be no amount of L in the composition.

The quantity of R present in the magnet material is dependent upon the chemical stoichiometry of the rare-earth-transition metal compound upon which the magnet materials are based. The quantity of R is approximately equal to or lower than the quantity of R present in the chemical stoichiometric composition. By having the quantity of R in the magnet material equal to or lower than the chemical stoichiometric amount of the rare earth in the rare earth-transition metal chemical compound, there is no rare-earth rich phase present in the magnet material. By rare-earth rich phase it is meant that a phase present in the magnet in which the quantity of the rare-earth is larger than the quantity of the rare-earth in the chemical compound.

For example, in one embodiment, the nanocrystalline or nanocomposite magnet material is based upon a RT₅ compound, the quantity of R present in the RT₅ chemical compound is 16.7 atomic percent. Therefore, the quantity of R present in the magnet is 16.7 atomic percent or lower when the chemical compound is RT₅. The quantity of R present in the magnet material changes as the chemical stoichiometry of the rare-earth transition metal compound changes. In another embodiment, the nanocrystalline or nanocomposite magnet material is based upon a RT₇ compound, the quantity of R present in the magnet will be equal or less than the quantity of R present in the chemical compound. For RT₇, the quantity of R present is 12.5 atomic percent. Thus, the quantity of R present in the magnet material is 12.5 atomic percent or lower when the chemical compound is RT₇, which is a different quantity than the previous example where the chemical compound is RT₅.

In yet another embodiment, the nanocrystalline or nanocomposite magnet material is based upon a R₂T₁₇ compound wherein the quantity of R is about 10.5 atomic percent. Thus, the quantity of R present in the magnet material is about 10.5 atomic percent or lower. In another embodiment, the nanocrystalline or nanocomposite magnet material is based upon a R₂T₁₄M compound, wherein the quantity of R is about 11.8 atomic percent. Therefore, the quantity of R present in the magnet material is about 11.8 atomic percent or lower. While these specific chemical compounds are explained, it is to be appreciated that the present invention is not limited to these compounds as the nanocrystalline or nanocomposite magnet material can be based upon other compounds.

A stated above, when the quantity of R present in the magnet material is equal to the quantity of R in the stoichiometry of the rare earth-transition metal compound, the magnet material can be nanocrystalline. However, when the quantity of R present in the magnet material is lower than the quantity of R in the stoichiometry of the rare earth-transition metal compound, then the magnet material can be nanocomposite. When the magnet material is a nanocomposite magnet, the magnet material comprises magnetically soft grains. The magnetically soft grains can be Fe, Co, Fe+Co, Fe₃B, or other soft magnetic materials containing Fe, Co, or Ni.

The quantity of the x and y also change according to the chemical compound. Table 1 below illustrates the values for x, y, and z using the chemical compounds explained above for the formula RₓT_{100-x-y}M_{y}L_{z}

TABLE 1

| Compound | | | | |
|---|---|---|---|---|
| with | | | | |
| Chemical | Content | | | |
| Stoichiometric | of R | | | |
| Composition | (at %) | X | y | z |
| RT₅ | 16.7 | about 3-about 16.7 | about 0-about 20 | about 0-about 16 |
| RT₇ | 12.5 | about 3-about 12.5 | about 0-about 20 | about 0-about 16 |
| R₂T₁₇ | 10.5 | about 3-about 10.5 | about 0-about 20 | about 0-about 16 |
| R₂T₁₄M | 11.8 | about 2-about 11.8 | about 2-about 25 | about 0-about 16 |

It is to be appreciated that in order to enhance the exchange coupling at the interface between the magnetically hard and soft grains, the impurities of the alloys should be minimized, since some impurity atoms turn to exist at the grain boundaries, which will weaken the exchange coupling at the interface.

The magnet materials may be in the form of powder particles, flakes, ribbons, and may be bulk, bonded, and non-bonded magnet materials. In addition, the magnets can be isotropic or anisotropic. By “isotropic” it is meant that the easy magnetization directions of the grains in a magnet material are randomly distributed and therefore on the whole the magnet material has basically the same magnetic properties along different directions. By “anisotropic” it is meant that the easy magnetization directions of the grains in a magnet material are aligned with a specific direction and therefore the magnet has different magnetic properties along different directions. The powder, flakes, and ribbons may be further processed to form into bulk magnet materials. By “bulk” it is meant that the magnet has a distinct and a relatively large size and mass, for example larger than about 3 mm and heavier than about 1 grams. The magnets can be fully dense, meaning that the density is equal or close to its theoretical x-ray density. In addition, the magnets may be non-bonded, meaning no binder is used during the process to make a bulk magnet. The magnets may also be bonded. By “bonded” we mean that the magnet was made with a binder. If the magnets are bonded then the binder may be epoxy, polyester, nylon, rubber, soft metals, or soft alloys. The soft metals may be selected from Sn, Zn, and combinations thereof. The soft alloys may be selected from Al—Mg, Al—Sn, Al—Zn, and combinations thereof.

The bulk isotropic magnet materials made by the above described processes may have a (BH)ₘₐₓ of at least 10 MGOe, and more specifically, from about 10 MGOe to about 20 MGOe. In addition, the bulk isotropic magnet materials may have a remanence from about 8 kG to about 10 kG. The bulk anisotropic magnet materials and the anisotropic powder magnet materials made by the above described processes may have a (BH)ₘₐₓ of at least 25 MGOe, and more specifically from about 25 MGOe up to about 90 MGOe, and about 30 MGOe to about 90 MGOe. In addition, the anisotropic magnet materials have a remanence from about 11 up to about 19 kG.

Also, the magnet materials may have intrinsic coercivity between about 5 kOe and about 20 kOe, and more specifically, an intrinsic coercivity between about 6 kOe and about 15 kOe. The bulk fully dense nanocomposite rare earth magnets may have a size between about 0.5 cm and about 15 cm, and more specifically between about 1 cm and about 6 cm.

The magnets of the invention can be formed by different methods. All of methods begin by preparing at least one alloy using an vacuum induction or arc melting. In one embodiment a small amount of one or a mixture of metals or alloys having a melting point lower than the hot deformation temperature can be used. The metals and alloys include, but are not limited to Mg, Sr, Ba, Zn, Cd, Al, Ga, In, Tl, Sn, Sb, Bi, Se, Te, and I (iodine), their alloys, and any other alloy with a melting point lower than about 950° C. One or a mixture of the additives are added to the at least one alloy during melting. Alternatively, one or mixtures of the additives can be blended with the rare earth-transition metal alloy powder prior to the hot press process, explained below.

The at least one alloy is placed in the form of powder particles by suitable conventional methods such as melt-spinning, mechanical alloying, high-energy mechanical milling, spark erosion, plasma spray, or atomization. Melt-spinning is typically used with a wheel surface linear speed of about 20 m/s to about 50 m/s. Mechanical alloying typically occurs from about 5 hours to about 80 hours. The prepared powder particles are in amorphous or nanograin conditions. As stated above, although the at least one alloy is discussed as being in the form of powder particles, it is to be appreciated that the at least one alloy can also be in the form of flakes or ribbons, or the like and these flakes or ribbons will be crushed into powders prior to further processing. In one embodiment, at least two alloy powders are blended together. Typically, on alloy powder has a rare earth content higher than that in the chemical stoichiometry of the rare earth-transition metal chemical compound, while another powder has a rare earth content lower than the chemical stoichiometry of the rare earth-transition metal chemical compound. The powders can both have a rare earth content lower than the chemical stoichiometry of the rare-earth-transition metal chemical compound.

After the at least one alloy is in the form of powder particles in an amorphous or nanograin condition, the methods begin to differ depending on the type of magnet material desired. A primary process used in the formation of the magnet is rapid hot press. During the rapid hot press step, the powders are heated, pressed, and cooled. The rapid hot press uses induction heating to heat the die and the metallic materials to be pressed. After the pressure is released, helium gas may be introduced to the chamber for rapid cooling. The die material can be a high strength metallic material, such as WC steel. In at least one embodiment, in the hot press process the powder or powder compact is heated directly using a DC, pulse DC, AC current (joule heat) or an eddy-current heat (induction heating). By heating directly, it is meant that the various currents mentioned above directly go through the powder particles to be compacted. The pressure of the rapid hot press can be between about 10 kpsi to about 30 kpsi. The temperature of the rapid hot press can be between about 600° C. and about 1100° C.

The rapid hot press may be performed in a vacuum, inert, or reduction atmosphere. If an inert atmosphere is used, typically argon gas is used. If a reduction atmosphere is used, typically a hydrogen gas is used. The rapid hot press step typically occurs between about 0.5 minutes to about 5 minutes, and more specifically between about 2 minutes to about 3 minutes. By performing the rapid hot press within this short amount of time, grain growth within the compacts may be prevented.

Below is an explanation of the methods used to form certain magnet materials. Examples follow the explanation of the methods to provide better understanding of the invention.

### Bulk, Fully Dense Isotropic Nanocrystalline and Nanocomposite Rare Earth Permanent Magnet

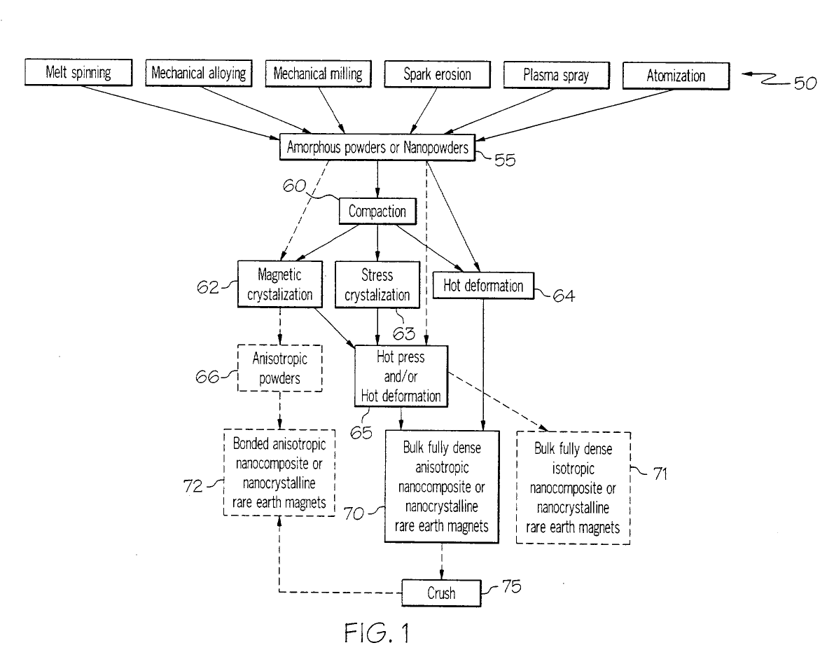

Referring to FIG. 1, methods for synthesizing bulk, fully dense isotropic nanocrystalline and nanocomposite rare earth permanent magnets will now be explained. The first step 50, as stated above, is to prepare powder, flakes, or ribbons of an alloy and then to crush them into powder from if necessary 55. After the alloy is in powder form, the alloy is subject to the rapid hot press process 65 as described above, to form a bulk, fully dens isotropic nanocrystalline and nanocomposite rare earth permanent magnet 71.

### Bulk, Fully Dense Anisotropic Nanocrystalline and Nanocomposite Rare Earth Permanent Magnet

Fully dense anisotropic nanocrystalline and nanocomposite permanent magnets can be synthesized. Easy magnetization directions of the hard and soft grains can be well aligned, therefore, uniform and strong exchange coupling may exist at the interface between the magnetically hard and soft grains.

One of three different processes can be used to synthesize bulk anisotropic nanocomposite rare earth permanent magnets, the elastic stress crystallization process, the magnetic crystallization process, and the hot deformation process. As shown in FIG. 1, the first step 50 in each of the three processes is to prepare the powder, or ribbons, or flakes as explained above. Each of the three processes is explained individually below.

Elastic Stress Crystallization Process

This process comprises four principal steps, the first step 50 being to prepare amorphous or nanograin alloy powders, flakes, or ribbons and to crush them into powder form if necessary 55 as described above. The second step 60 is to compact the powder at room temperature or temperatures lower than the crystallization temperature of the corresponding amorphous alloy and a pressure between about 5 kpsi and about 30 kpsi. The compaction temperature may not higher than about 400° C. in most cases in order to prevent any crystallization or grain growth. The compaction of the powder can be performed by conventional die press, hot press, hot roll, elevated temperature isostatic press, dynamic magnetic compaction, or any suitable device used in the art.

After compaction, the green compacts endure a stress crystallization step 63 where the compacts are crystallized at a temperature between about 500° C. and about 800° C. for a period of about five seconds up to about two hours. It is to be appreciated that the temperature may vary depending upon the alloy systems. The crystallization occurs under a strong and uniform elastic stress. The stress is applied at a pressure between about 2 kpsi and about 20 kpsi. The elastic stress typically does not exceed the yield strength of the magnetically hard grain at the corresponding temperature.

The applied elastic stress will induce an easy magnetic direction. Depending on alloy system and compositions, this easy magnetization direction can be either perpendicular to the stress direction or the easy magnetization direction can be parallel to the stress direction. The stress crystallization is performed in a vacuum, inert atmosphere, or reducing atmosphere. If an inert atmosphere is used, typically argon gas is used. If a reducing atmosphere is used, typically a hydrogen gas is used.

After the stress crystallization step 63, the alloy compacts can be subjected the rapid hot press 65 as explained above to further increase the density and improve the mechanical strength and form a bulk, fully dense anisotropic nanocrystalline and nanocomposite rare earth permanent magnet 70.

Also, the magnet can be subjected to the hot deformation to further enhance its anisotropy and magnetic performance. The hot deformation step is typically performed between about one minutes to about 60 minutes, and more specifically between about two minutes to about 30 minutes. The pressure applied to the powder compact or powders can be between about 2 kpsi to about 10 kpsi. The temperature used during the hot deformation step can be between about 630° C. and about 1050° C. The strain rate can be between 10⁻⁴/second and about 10⁻²/second. By “strain rate” it is meant that the amount of relative deformation per unit time. The hot deformation step may be performed in a vacuum, inert, or reducing atmosphere. If an inert atmosphere is used, typically argon gas is used. If a reducing atmosphere is used, typically a hydrogen gas is used.

Magnetic Crystallization Process

This process comprises four principal steps, the first and second steps being taught above. The first step 55 is to prepare amorphous or nanograin alloy powders 55 as described above. The second step 60 is to compact the powder as explained above for the elastic stress crystallization process.

After the compaction step 60 the compact endures a magnetic crystallization step 62. During the magnetic crystallization step 62, the compacts are subjected to a heat treatment in a strong magnetic field. By strong magnetic field it is meant that a magnetic field that is higher than about 5000 Oe. The magnetic field should be sufficient high to develop a permanent uniaxial anisotropy with the easy axis parallel to the direction of the magnetic field during the heat treatment. By unaxial anisotropy it is meant that the easy magnetization direction is along only one specific crystallographic axis. The magnetic field strength can be between about 6 kOe to about 15 kOe or higher. It is to be appreciated that the temperature will vary depending upon the alloy used to make the compact. The compacts can be annealed at temperatures between about 500° C. to about 800° C. for a period of about five seconds up to about two hours. The magnetic crystallization may be performed in a vacuum, inert, or reduction atmosphere. If an inert atmosphere is used, typically argon gas is used. If a reduction atmosphere is used, typically a hydrogen gas is used.

During the annealing, crystallization will occur in an amorphous or partially amorphous alloy. When both the magnetically hard grains and the magnetically soft grains have Curie temperatures higher than the magnetic crystallization temperature, the magnetic crystallization may occur in a manner that aligns the easy magnetization directions of the crystallized grains with the direction of the applied magnetic field, which minimizes the magneto-crystalline energy.

For example, the crystallization temperature of amorphous Sm₂Co₁₇/Co nanocomposite material is between about 600° C. and about 700° C., far below the Curie temperature of the hard grains (about 920° C.) and the soft grains (about 1120° C.). Therefore, magnetic annealing the Sm₂Co₁₇/Co nanocomposite material would produce an anisotropic nanocomposite Sm₂Co₁₇/Co material.

If the magnetically hard grains have a Curie temperature lower than the magnetic crystallization temperature, direct alignment may not be reached. For example, the Curie temperature of the magnetically hard grains in the Nd₂Fe₁₄B/α-Fe nanocomposite magnet is 312° C., significantly lower than the crystallization temperature of the amorphous alloy, which can be between about 550° C. and 650° C. However, while not wishing to be bound to one particular theory, it is believed that proper magnetic annealing can still produce anisotropic Nd₂Fe₁₄B/α-Fe type nanocomposite magnets.

When annealing Nd₂Fe₁₄B/α-Fe type amorphous alloy, the α-Fe grains first crystallize at around 560° C., while the hard Nd₂Fe₁₄B grains crystallize at a substantially higher temperature of 650° C.-700° C. If a strong magnetic field is applied at the beginning of the crystallization annealing, the easy magnetization direction of the α-Fe grains can be aligned because the Curie temperature of α-Fe (780° C.) is higher than the crystalline temperature. Following this stage, at higher temperature, when the Nd₂Fe₁₄B grains crystallize, a coherent nucleation and growth with the pre-aligned α-Fe grains would be favorable for reducing the interface free energy. In this way the magnetically hard Nd₂Fe₁₄B grains can be indirectly aligned.

After the magnetic crystallization step 62, the alloy compacts can be subjected to a rapid hot press 65 as explained above to further increase the density and improve the mechanical strength for form a bulk, fully dense anisotropic nanocrystalline and nanocomposite rare earth permanent magnet 70.

Also, the magnet can be subjected to a hot deformation process to further enhance its anisotropy and magnetic performance. If hot deformation is used, the hot deformation step is typically performed between about one minutes to about 60 minutes, and more specifically between about two minutes to about 30 minutes. The pressure applied to the powder compact or powders can be between about 2 kpsi to about 10 kpsi. The temperature used during the hot deformation step can be between about 630° C. and about 1050° C. The strain rate can be between 10⁻⁴/second and about 10⁻²/second. By “strain rate” it is meant that the amount of relative deformation per unit time. The hot deformation step may be performed in a vacuum, inert, or reducing atmosphere. If an inert atmosphere is used, typically argon gas is used. If a reducing atmosphere is used, typically a hydrogen gas is used.

Hot Deformation Process

This process comprises three principal steps, the first and second steps being taught above. The first step 55 is to prepare amorphous or nanograin alloy powder particles 55 as described above. The second step 60 is to compact the powders as explained above for the elastic stress crystallization process. Alternatively, this compaction 60 can be performed using the rapid hot press process as described previously. For the next step, a die-up setting is typically used for the hot deformation process. During this process, crystallization, if an amorphous compact is used, and plastic flow occur at the same time. While not wishing to be bound to one particular theory, it is believed that the grain rotation and/or selective grain growth during this process will lead to an anisotropic magnet. The easy magnetization direction may be parallel to the applied stress. After the hot deformation is completed, helium gas may be introduced to the chamber for rapid cooling to a temperature between about 250° C. and about 350° C.

The hot deformation step is typically performed between about one minutes to about 60 minutes, and more specifically between about two minutes to about 30 minutes. The pressure applied to the powder compact or powders can be between about 2 kpsi to about 10 kpsi. The temperature used during the hot deformation step can be between about 630° C. and about 1050° C. The strain rate can be between 10⁻⁴/second and about 10⁻²/second. By “strain rate” it is meant that the amount of relative deformation per unit time. The hot deformation step may be performed in a vacuum, inert, or reducing atmosphere. If an inert atmosphere is used, typically argon gas is used. If a reducing atmosphere is used, typically a hydrogen gas is used.

If the compact to be hot deformed is an isotropic magnet material, magneto-crystalline anisotropy can be established by hot deformation 64. If the compact to be hot deformed is an anisotropic magnet material prepared using elastic stress crystallization or magnetic crystallization as described above, the anisotropy can be enhanced by the hot deformation.

A rare earth-rich phase is typically used in synthesizing both conventional sintered Nd—Fe—B magnets and conventional hot-pressed and hot-deformed Nd+Fe+B magnets. The role of the rare earth-rich phase is to ensure the sintered and hot-pressed and hot-deformed Nd+Fe+B magnets to possess full density. Also, to make it possible for the hot deformation to take place without cracking. The melting point of the rare earth-rich phase is about 685° C. and the hot deformation is carried out at temperatures typically above 700° C. While not wishing to be bound to one particular theory, it is believed that the rare earth-rich phase is melted in the hot deformation process and act as a lubricant for the deformation. The role of the rare earth-rich phase is also to facilitate the formation of the required crystalline texture during the hot deformation and, hence, lead to anisotropic magnets. Finally, the role of the rare earth-rich phase is to develop useful coercivity in conventional sintered and hot-pressed and hot-deformed Nd—Fe—B magnets.

In the nanocrystalline and nanocomposite magnets covered in this invention, there is no rare earth-rich phase. Further, in a nanocomposite magnet, the rare earth content is lower than that in the chemical stoichiometric amount of the rare earth-transition metal compound and, thus, there exists a magnetically soft phase, such as α-Fe. In a nanocrystalline rare earth permanent magnet, a high uniaxial magnetocrystalline anisotropy is the typical requirement for high coercivity. While not wishing to be bound to one particular theory, it is believed that a direct connection between coercivity and magnetocrystalline anisotropy is established in nanostructured permanent magnet materials. Therefore, the rare earth-rich phase is no longer needed for the development of coercivity in the present invention.

Additional steps may be applied when using hot deformation. These steps help to prevent cracking and to synthesize anisotropic nanocrystalline and nanocomposite rare earth magnets. The first is using powder blending to make nanocrystalline and nanocomposite rare earth magnets. For example, an anisotropic nanocomposite R₁₀Fe₈₄B₆ magnet can be prepared y hot pressing and hot deforming an appropriate mixture of R₁₃Fe₈₁B₆ and R₆Fe₈₈B₆ powders. It is believed that the existence of a localized rare earth-rich phase will be also beneficial to the hot deformation and crystal texture formation. Details of this method are given in Example 22 and 23.

The other step is to add at least one metal or at least one alloy that has low melting temperature into the magnet alloys. The at least one metal or at least one alloy may act as a lubricant and, therefore, facilitate the hot deformation and crystalline texture formation. In addition to pure metals, alloys with meting points lower than ˜700° C. can be also used for this purpose. Examples of this kind of metals and alloys and their melting temperature are given in Table 2. These low-melting-point metals or alloys can be added into magnet alloys during melting prior to melt spinning, mechanical alloying, or other powder preparation steps. Alternately, a small amount of powder of these low-melting-point metals or alloys can be mixed with the rare earth-transition metal alloy powder before the hot press.

TABLE 2
Metals and alloys with low melting point.

| Metal | Melting point (° C.) |
|---|---|
| Al | 660 |
| Mg | 650 |
| Zn | 419.5 |
| Ga | 29.8 |
| Se | 217 |
| Cd | 320.9 |
| In | 156.2 |
| Sn | 231.9 |
| Sb | 630.5 |
| Te | 449.5 |
| I | 113.7 |
| Ba | 714 |
| Tl | 303 |
| Bi | 271.3 |
| Al—Cu | 548.2 |
| Al—Ge | 420 |
| Al—In | 639 |
| Al—Mg | 450 |
| Al—Sn | 228 |
| Al—Zn | 381 |
| Bi—Mg | 260, 553 |
| Bi—Mn | 262 |
| Ba—I | 712 |

The facility for hot press and hot deformation may also affect the density obtained after the hot press and may affect the hot deformation process. The heating mechanism strongly affects the hot press process. When the powder to be hot pressed is heated directly using a DC, pulse DC, or AC current (Joule heat) or using eddy-current (eddy-current heat), high density equal or very close to the theoretical density values can be readily obtained after the hot press. However, when the powder to be hot pressed is heated using radiate heating, it may be difficult to obtain high density after the hot press.

The die material may also affect the hot press process. Dies made of a hard WC steel material may be used rather than the commonly used graphite dies, which allows applying a high pressure of 40 kpsi or higher and maintaining the die integrity. During the hot press, a thin carbide film may be used as a lubricant to reduce the friction between the powder and the die.

### Bonded Anisotropic Nanocrystalline and Nanocomposite Rare Earth Magnet Material

The methods for synthesizing a bonded anisotropic nanocrystalline and nanocomposite rare earth magnet material will now be explained. The first step 50, as explained above is to prepare the alloy in powder particles 55.

Next, the powder particles are subject to a magnetic crystallization step 62. As explained above, during the magnetic crystallization step, the powders are subjected to a heat treatment in a strong magnetic field. The magnetic field strength can be between about 6 kOe to about 15 kOe or higher. The powder particles can be annealed at temperatures between about 500° C. to about 800° C. for a period of about five seconds up to about two hours. The magnetic crystallization may be performed in a vacuum, inert, or reducing atmosphere. If an inert atmosphere is used, typically argon gas is used. If a reducing atmosphere is used, typically a hydrogen gas is used. As explained above, this process creates anisotropic nanocrystalline or nanocomposite powder particles 66.

The anisotropic powder particles can be used combined with a binder to make a bonded anisotropic nanocrystalline or nanocomposite bonded rare earth magnets 72. The weight percent of the binder is from about 1 wt % to about 10 wt %. The binder can be selected from epoxy, polyester, nylon, rubber, or soft metals or alloys, and combinations thereof. The mixture of the alloy powder and binder then is subjected to a compaction under a pressure between about 10 kpsi to about 50 kpsi in a strong magnetic field greater than about 10 kOe.

A second method of synthesizing bonded anisotropic nanocrystalline or nanocomposite rare earth magnet is to crush 75 a bulk fully dense anisotropic nanocrystalline or nanocomposite rare earth magnet 70 that is prepared in one of the three methods described above. This bulk fully dense anisotropic nanocrystalline or nanocomposite rare earth magnet can be crushed with any appropriate devices into powder particles of about one micron to about 400 microns, and more specifically between about 50 microns to about 200 microns. The powder particles can be combined with a binder as described in the previous paragraph to form a bonded anisotropic nanocrystalline or nanocomposite rare earth magnet 72. Tables 3 and 4 are summaries of melt-spun and hot pressed and hot deformed nanocomposite magnets along with their processing temperature (T), pressure (P), strain (when applicable), density, and magnetic properties, respectively.

TABLE 3

| | | | | | | | Amount of |
|---|---|---|---|---|---|---|---|
| Nominal composition | T | P | Density | Bᵣ | _{M}H_{c} | (BH)ₘₐₓ | α-Fe˜ |
| (at. %) | (° C.) | (kpsi) | (g/cm³) | (kG) | (kOe) | (MGOe) | vol % |
| Nd_{2.2}Pr_{2.8}Dy₁B₆Co₅Fe₈₃ | 650 | 25 | 7.68 | 9.47 | 5.37 | 11.77 | 46 |
| Nd_{2.4}Pr_{5.6}Dy₁B₆Fe₈₅ | 680 | 20 | 7.49 | 7.8 | 5.8 | 8.8 | 22 |
| Pr₉B_{5.5}Co₄Nb_{0.3}Fe_{81.2} | 700 | 20 | 7.62 | 8.2 | 5.86 | 10.5 | 22 |
| Nd₈Pr_{1.4}Dy_{0.5}B_{5.8}Co_{5.9}Ga_{0.1}Fe_{78.3} | 700 | 25 | 7.65 | 8.7 | 9.3 | 13.3 | 15 |
| Nd₅Pr₅Dy₁B₁₀Co₆Fe₇₃ | 720 | 20 | 7.41 | 7.71 | 5.47 | 11.23 | 4 |
| Nd_{9.2}Pr₁Dy_{0.3}B_{5.7}Co_{6.1}Ga_{0.2}Al_{0.2}Fe_{77.3} | 700 | 25 | 7.7 | 8.4 | 10.7 | 13 | 11 |
| Nd_{9.7}Pr₁Dy_{0.3}B_{5.7}Co_{6.1}Ga_{0.3}Fe_{76.9} | 680 | 25 | 7.67 | 8.35 | 11.62 | 13.05 | 8 |
| Nd_{10.1}Pr_{0.8}Dy_{0.3}B_{5.9}Co_{3.6}Fe_{79.3} | 650 | 25 | 7.61 | 8.02 | 12.99 | 12.85 | 6 |
| Nd_{10.3}Pr_{0.8}Dy_{0.3}B_{5.9}Co_{3.6}Fe_{79.1} | 660 | 25 | 7.6 | 8.23 | 13.48 | 13.54 | 5 |
| Nd_{10.7}Pr_{0.7}Dy_{0.2}B_{5.6}Co_{6.3}Ga_{0.4}Fe_{76.1} | 650 | 25 | | 8.18 | 14.94 | 13.34 | 4 |
| Nd_{11.8}B_{5.5}Co_{5.5}Fe_{77.2} | 670 | 25 | 7.66 | 8.7 | 6.7 | 14.2 | 4 |

TABLE 4

| | | | | | | | | Amount of |
|---|---|---|---|---|---|---|---|---|
| Nominal composition | T | P | Strain | Density | Bᵣ | _{M}H_{c} | (BH)ₘₐₓ | α-Fe˜ |
| (at. %) | (° C.) | (kpsi) | (%) | (g/cm³) | (kG) | (kOe) | (MGOe) | vol % |
| Nd_{2.2}Pr_{2.8}Dy₁B₆Co₅Fe₈₃ | 920 | 6 | 40 | 7.7 | 7.63 | 2.64 | 5.34 | 46 |
| Nd_{7.7}B_{5.7}Fe_{86.6} | 920 | 6 | 40 | 7.68 | 8.41 | 1.95 | 4.89 | 32 |
| Nd_{2.4}Pr_{5.6}Dy₁B₆Fe₈₅ | 930 | 5 | 59 | 7.44 | 8 | 2.05 | 4.51 | 22 |
| Pr₉B_{5.5}Co₄Nb_{0.3}Fe_{81.2} | 740 | 6 | 41 | 7.61 | 9.19 | 2.54 | 9.86 | 22 |
| Nd₅Pr₅Dy₁B₁₀Co₆Fe₇₃ | 910 | 6 | 50 | 7.6 | 9.2 | 2 | 7.70 | 4 |
| Nd_{9.2}Pr₁Dy_{0.3}B_{5.7}Co_{6.1}Ga_{0.2}Al_{0.2}Fe_{77.3} | 850 | 5 | 39 | 7.65 | 11.62 | 7.42 | 23.93 | 11 |
| Nd_{9.7}Pr₁Dy_{0.3}B_{5.7}Co_{6.1}Ga_{0.3}Fe_{76.9} | 850 | 5 | 43 | 7.63 | 10.85 | 8.398 | 21.84 | 8 |
| Nd_{10.1}Pr_{0.8}Dy_{0.3}B_{5.9}Co_{3.6}Fe_{79.3} | 770 | 5 | 50 | 7.6 | 12 | 7.71 | 26.88 | 6 |
| Nd_{10.3}Pr_{0.8}Dy_{0.3}B_{5.9}Co_{3.6}Fe_{79.1} | 760 | 5 | 57 | 7.6 | 11.94 | 7.32 | 26.91 | 5 |
| Nd_{10.7}Pr_{0.7}Dy_{0.2}B_{5.6}Co_{6.3}Ga_{0.4}Fe_{76.1} | 760 | 5 | 55 | 7.55 | 12.01 | 10.64 | 31.00 | 4 |
| Nd_{10.7}Pr_{0.7}Dy_{0.2}B_{5.6}Co_{6.3}Ga_{0.4}Fe_{76.1} | 840 | 5 | 60 | 7.6 | 13.14 | 10.55 | 36.30 | 4 |
| Nd_{10.8}Pr_{0.6}Dy_{0.2}B_{5.6}Co_{6.3}Ga_{0.2}Al_{0.2}Fe_{76.1} | 860 | 4 | 60 | 7.58 | 13.1 | 10.84 | 37.24 | 4 |
| Nd_{10.8}Pr_{0.6}Dy_{0.2}B_{5.6}Co_{6.3}Ga_{0.2}Al_{0.2}Fe_{76.1} | 880 | 4 | 60 | 7.61 | 12.67 | 11.51 | 36.13 | 4 |
| Nd_{10.8}Pr_{0.6}Dy_{0.2}B_{5.6}Co_{6.3}Ga_{0.2}Al_{0.2}Fe_{76.1} | 890 | 4 | 60 | 7.59 | 13.01 | 11.43 | 37.77 | 4 |
| Nd_{10.8}Pr_{0.6}Dy_{0.2}B_{5.6}Co_{6.3}Ga_{0.2}Al_{0.2}Fe_{76.1} | 900 | 4 | 60 | 7.64 | 13.22 | 10.64 | 37.81 | 4 |
| Nd_{10.8}Pr_{0.6}Dy_{0.2}B_{5.6}Co_{6.3}Ga_{0.2}Al_{0.2}Fe_{76.1} | 920 | 3 | 60 | 7.64 | 13.27 | 10.72 | 38.62 | 4 |
| Nd_{10.8}Pr_{0.6}Dy_{0.2}B_{5.6}Co_{6.3}Ga_{0.2}Al_{0.2}Fe_{76.1} | 940 | 3 | 60 | 7.65 | 12.93 | 9.47 | 34.47 | 4 |

The present invention will be further explained by way of examples. It is to be appreciated that the present invention is not limited by these examples.

For examples 1-11, a PAR Model 155 vibrating sample magnetometer was used to determine the magnetic properties.

### EXAMPLE 1

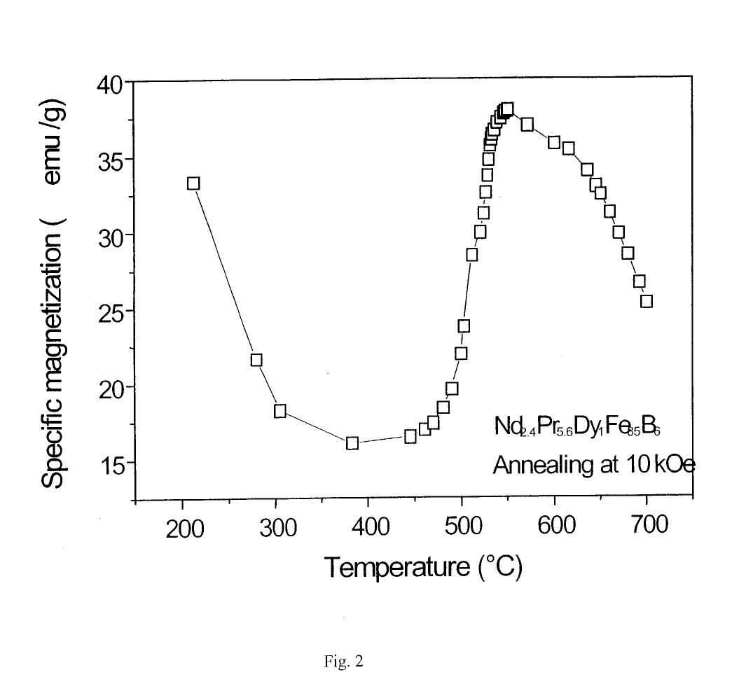

Referring to FIG. 2, the temperature dependence of magnetization of a Nd_{2.4}Pr_{5.6}Dy₁Fe₈₅B₆ alloy is shown. The alloy was melt-spun at a speed between 20 to 50 m/s and then compacted at room temperature. Upon heating the melt-spun amorphous Nd_{2.4}Pr_{5.6}Dy₁Fe₈₅B₆ alloy, its magnetization at a 10 kOe DC magnetic field sharply drops until about 450° C. Continue to heat leads to a sharp increased magnetization and it reaches a peak at about 550° C. The magnetization of this alloy at 550° C. is more than twice as high as that at 380° C. The Curie temperature of the (Nd,Pr,Dy)₂Fe₁₄B is around 300° C., it apparent that the sharp increase of magnetization at 450° C. to 550° C. signifies the crystallization of the α-Fe phase. α-Fe has body centered cubic crystal structure. Its magnetocrystalline anisotropic is smaller as comparing with the Nd₂Fe14B compound. However, its value is still as large as 5×10⁵ erg/cm³.

For examples 2-6, the alloys were melt-spun at a speed between 2-50 m/s and then compacted at room temperature. The compacts endure magnetic crystallization and the compacts is annealed with a magnetic field or without a magnetic field.

### EXAMPLE 2

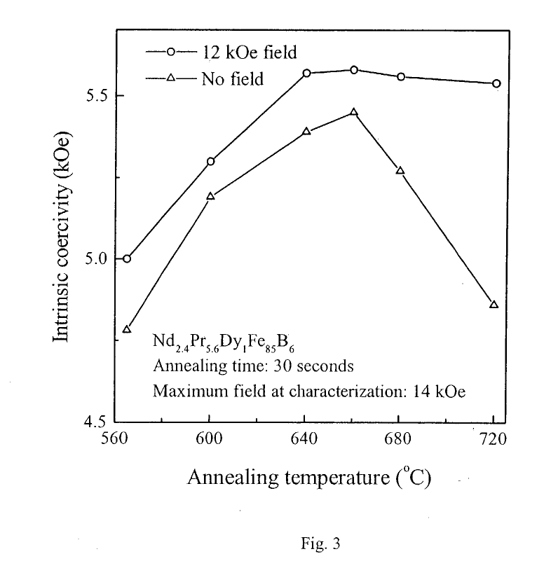

Referring to FIG. 3, the effect of magnetic annealing on intrinsic coercivity of a melt-spun Nd_{2.4}Pr_{5.6}Dy₁Fe₈₅B₆ magnet alloy. The alloy was annealed at temperatures between 565° C. and 720° C. for 30 seconds. The magnetic field strength for the magnetic annealing was 12 kOe. The effect of the magnetic field applied in annealing on the coercivity is apparent, especially when annealed at higher temperature. When annealed at 720° C., the improvement of the intrinsic coercivity is as high as 14%.

### EXAMPLE 3

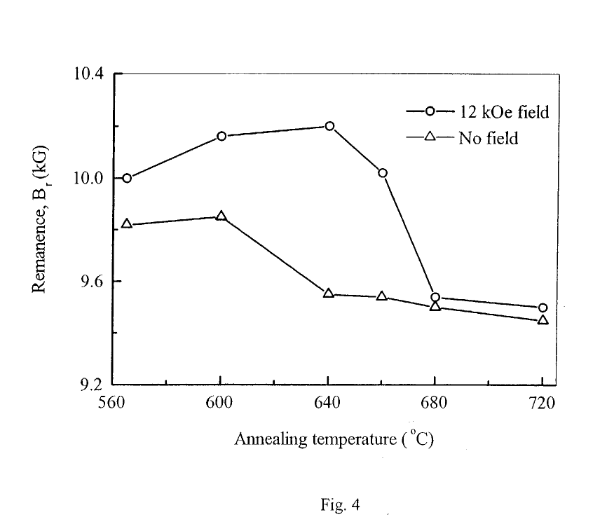

Referring to FIG. 4, the effect of magnetic annealing on remanence of a melt-spun Nd_{2.4}Pr_{5.6}Dy₁Fe₈₅B₆ magnet alloy is shown. The annealing temperatures are about 565° C. to about 720° C. and the annealing time is 30 seconds. The magnetic field strength for the magnetic annealing was 12 kOe. The best effect of the magnetic annealing for remanence was obtained when annealed at 640° C. and the improvement is 7 %.

### EXAMPLE 4

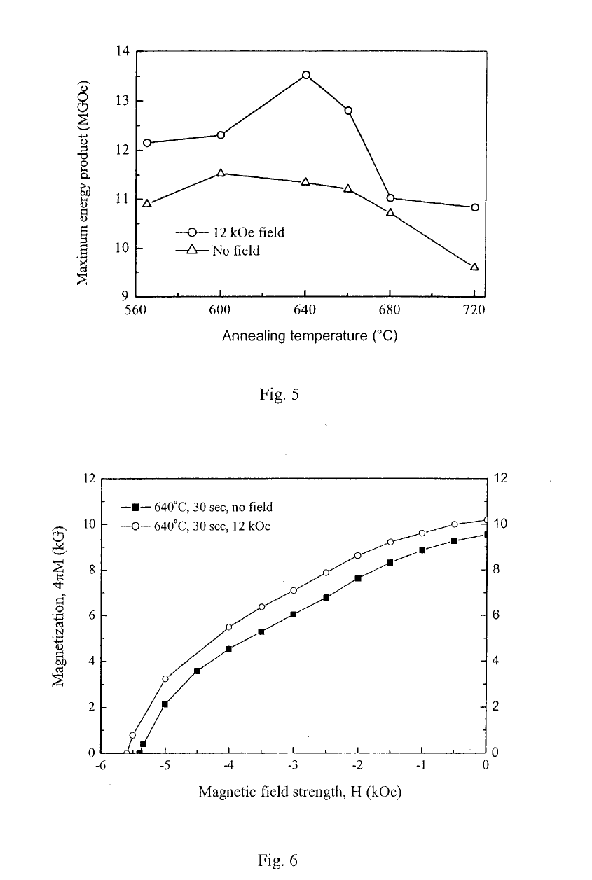

Referring to FIG. 5, the effect of magnetic annealing on the maximum energy product of a melt-spun Nd_{2.4}Pr_{5.6}Dy₁Fe₈₅B₆ magnet alloy is shown. The annealing temperatures are about 565° C. and about 720° C., and the annealing time is 30 seconds. The magnetic field strength for the magnetic annealing is 12 kG. The best effect of the magnetic annealing for energy product is obtained when annealed at 640° C., and the improvement is 19%.

### EXAMPLE 5

Referring to FIG. 6, demagnetization curves of melt-spun Nd_{2.4}Pr_{5.6}Dy₁Fe₈₅B₆ annealed at 640° C. for 30 seconds in a 12 kOe DC magnetic without the magnetic field. Applying a magnetic field during the anneal results in increased remanence, intrinsic coercivity, and maximum energy product.

### EXAMPLE 6

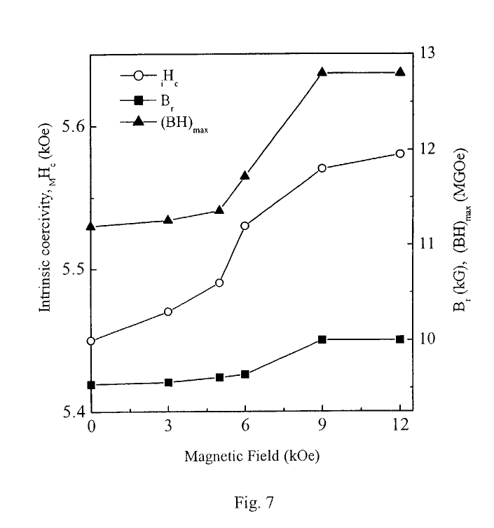

Referring to FIG. 7, the effect of the magnetic field strength in the magnetic annealing on magnetic properties of a melt-spun Nd_{2.4}Pr_{5.6}Dy₁Fe₈₅B₆ magnet alloy is shown. The annealing is performed at 660° C. for 30 seconds. In the magnetic anneal, the magnetic performance improved with increasing the magnetic field up to 9 kOe, and then remained almost the same with further increasing the magnetic field strength to 12 kOe.

In examples 7 and 8, the alloys are mechanically milled for about 5-80 hours and then compacted at room temperature. The compacts are then subjected to magnetic crystallization and annealed without a magnetic field and also with a magnetic field.

### EXAMPLE 7

Table 5 shows the magnetic properties of mechanically milled SmCo_{9.5} and Sm(Co_{0.88}Fe_{0.12})_{9.5} alloys annealed at 660° C. for 5 min or 750° C. for 1 min with without a 10 kOe field. In Table 5, F represents anneal with the 10 kOe field. NF represents anneal without the magnetic field. Compared with the samples annealed without the magnetic field, there is an improvement in the intrinsic coercivity _{M}H_{c}, the remanence Bᵣ, and the maximum magnetic energy product (BH)ₘₐₓ for both SmCo_{9.5} and Sm(Co_{0.88}Fe_{0.12})_{9.5} alloys annealed in a magnetic field of 10 kOe.

TABLE 5

| | | Bᵣ | _{M}H_{c} | Hₖ | (BH)ₘₐₓ |
|---|---|---|---|---|---|
| Sample | Anneal | (kG) | (kOe) | (kOe) | (MGOe) |
| SmCo_{9.5} | F, 750° C. | 8.7 | 7.6 | 2.7 | 14.6 |
| | NF, 750° C. | 8.6 | 7.3 | 1.5 | 11.1 |
| | F, 660° C. | 8.8 | 6.1 | 1.9 | 12.7 |
| | NF, 660° C. | 8.7 | 5.8 | 1.4 | 10.8 |
| Sm(Co_{0.88}Fe_{0.12})_{9.5} | F, 750° C. | 9.6 | 6.0 | 1.7 | 14.2 |
| | NF, 750° C. | 9.5 | 5.9 | 1.5 | 13.2 |
| | F, 660° C. | 10.1 | 3.5 | 1.3 | 12.5 |
| | NF, 660° C. | 9.9 | 3.4 | 1.2 | 11.7 |

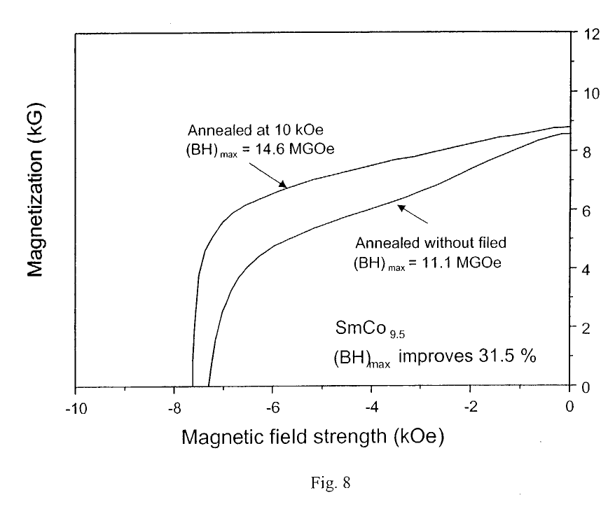

Referring to FIG. 8, the demagnetization curves of mechanically alloyed nanocomposite SmCo_{9.5} when annealed with and without a 10 kOe DC magnetic field at 750° C. for 1 minute are shown. The maximum energy products of the two magnet alloys are 11.1 and 14.6 MGOe, respectively. The improvement of the maximum energy product by the magnetic annealing is 31.5%.

### EXAMPLE 8

A mechanically alloyed nanocrystalline SmCo₇ was milled in Ar for 16 hours using SPEX 8000 mill/Mixer followed by an anneal at 750° C. for 1 minute with and without a 12 kOe magnetic field. The maximum energy product is about 10.6 MGOe, which shows an improvement over the annealing without a magnetic field. Also, the remanence is 7.2 kGs, which is also an improvement over the alloy annealed without a magnetic field.

For examples 9-11, the alloys are mechanically milled for about 5-80 hours and then compacted at room temperature. The compacts are annealed without a magnetic field.

### EXAMPLE 9

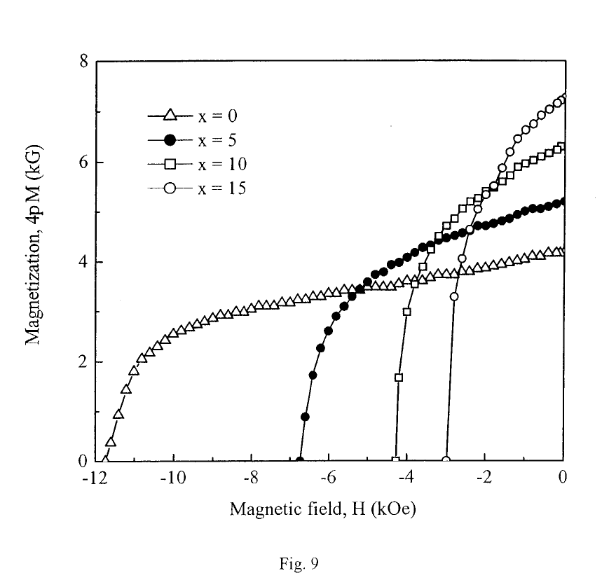

Referring to FIG. 9, the demagnetization curves of a mechanically alloyed nanocrystalline YCo₅ magnet and nanocomposite (100-x) wt % YCo₅/x wt % α-Fe magnets with x=5, 10, and 15 annealed at 750° C. for 2 minutes are shown. The nanocrystalline YCo₅ magnet has a high coercive force of near 12 kOe.

### EXAMPLE 10

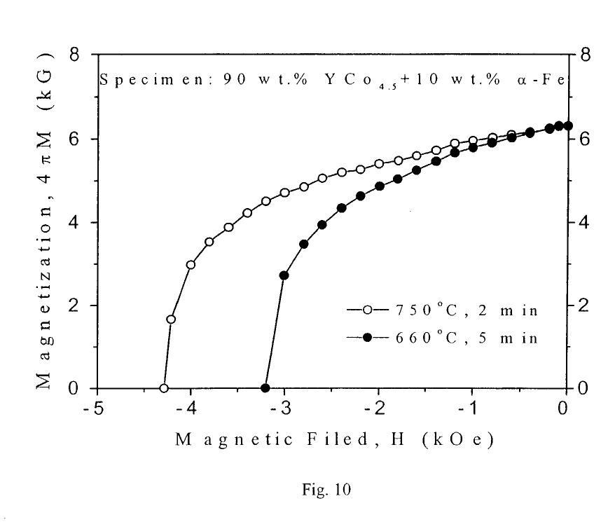

Referring to FIG. 10, the demagnetization curves of a mechanically alloyed nanocomposite 90 wt % YCo_{4.5}+10 wt % α-Fe alloy annealed at 660° C. and 750° C. for 2 minutes, respectively, are shown. It can be seen that the coercivity of the magnet alloy is sensitive to the annealing temperature.

### EXAMPLE 11

Referring to FIG. 11, the demagnetization curves of mechanically alloyed nanocomposite Y₁₀Fe_{83.1}Cr_{0.9}B₆ and Y₁₀Fe₇₈Cr₆B₆ annealed at 660° C. for 2 minutes are shown. The Y₁₂Fe₁₄B compound has a relatively low magnetocrystalline anisotropy constant as compared with the Nd₂Fe₁₄B compound. Substitution of Cr for Fe can increase the magnetocrystalline anisotropy of Y₁₂Fe₁₄B and, hence, its coercivity in nanocomposite magnets.

For Examples 12-30, the magnetic alloys are prepared using an induction melting. Melt spinning is then used to make ribbons with a wheel surface linear speed of about 20 to about 50 m/s. The ribbons are then crushed into powder particles of about 100 to about 300 microns. The hot press and hot deformation conditions are provided for each example as applicable. Closed circuit magnetic characterizations, using a cylinder specimen with 1.27 cm in diameter, were performed using a hysteresisgraph (Model HG-105 from KJS Associates) at room temperature. Scanning electron microscopy (SEM) is used to observe the fracture surface of hot-deformed magnets with JEOL JSM-840A. Transmission electron microscopy (TEM) and selected area electron diffraction (SAED) were used to observe microstructures and analyze crystal structures of hot-pressed and hot-deformed magnets.

### EXAMPLE 12

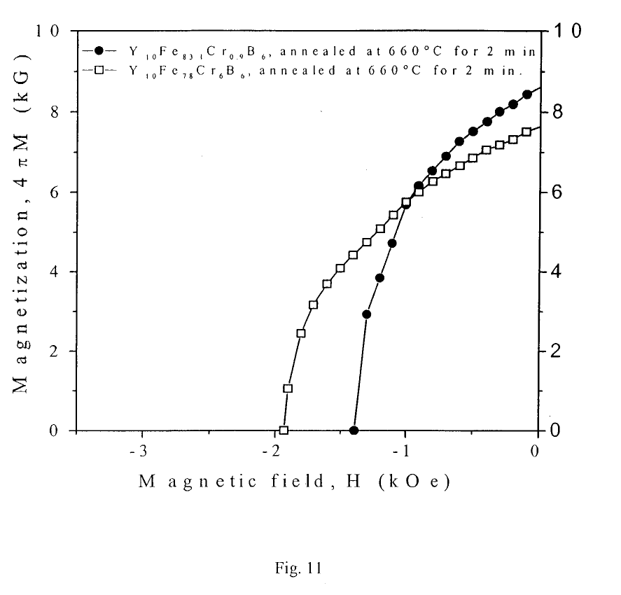

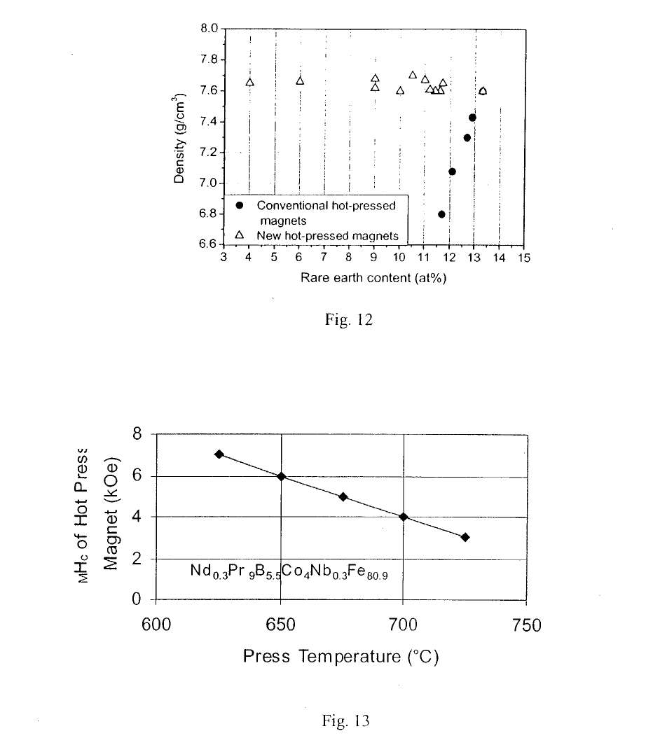

Referring to FIG. 12, the dependence of the density for melt-spun and hot pressed nanocomposite and nanocrystalline (Nd, Pr, Dy)₂Fe₁₄B/α-Fe based magnets and a comparison with the conventional hot pressed Nd—Fe—B magnets is shown. When the rare earth content is lower than about 13.5 at %, full density cannot be reached in conventional hot-pressed magnets. However, for hot pressed nanomagnets described in this invention, full density can be reached for magnets containing rare earth ranging from 4 at % to 13.5 at %,. For conventional hot-pressed Nd—Fe—B magnets with chemical stoichiometric composition, the density obtained is 6.8 g/cm³. However, in this study, full density was achieved for the hot-pressed nanocomposite magnets even when the rare earth content was as low as 4 at %.

### EXAMPLE 13

Referring to FIG. 13, the dependence of intrinsic coercivity of melt spun and hot pressed Pr₉Fe_{8.12}Co₄Nb_{0.3}B_{5.5} on hot pressed temperature is shown. A lower hot pressed temperature leads to higher coercivity.

### EXAMPLE 14

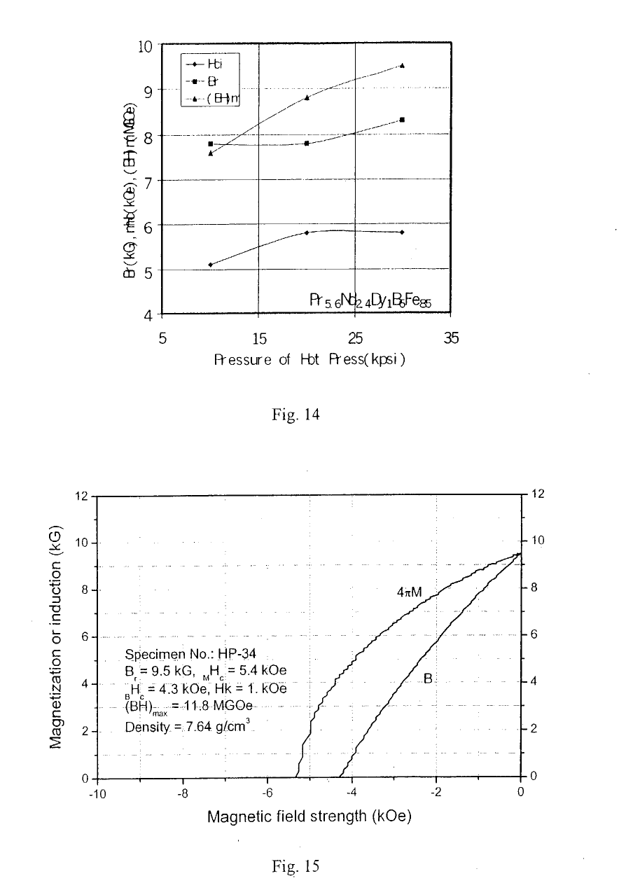

Referring to FIG. 14, the magnetic properties versus the hot press pressure are shown. High hot press pressure is favorable to remanence, Bᵣ, intrinsic coercivity, _{M}H_{c}, and maximum energy product, (BH)ₘₐₓ.

### EXAMPLE 15

Referring to FIG. 15, demagnetization curves and magnetic properties of a hot-pressed bulk fully dense isotropic magnet specimen of Nd_{2.2}Pr_{2.8}Dy₁Fe₈₃Co₅B₆ are shown. This magnet was hot pressed at 650° C. with a pressure of 25 kpsi. The density of the magnets is 7.64 g/cm³. The total nominal rare earths content of this magnet is 6 at %. The metallic part of total rare earths content of the magnet is about 5.7 at %. The α-Fe content in the magnets is about 46 vol %.

### EXAMPLE 16

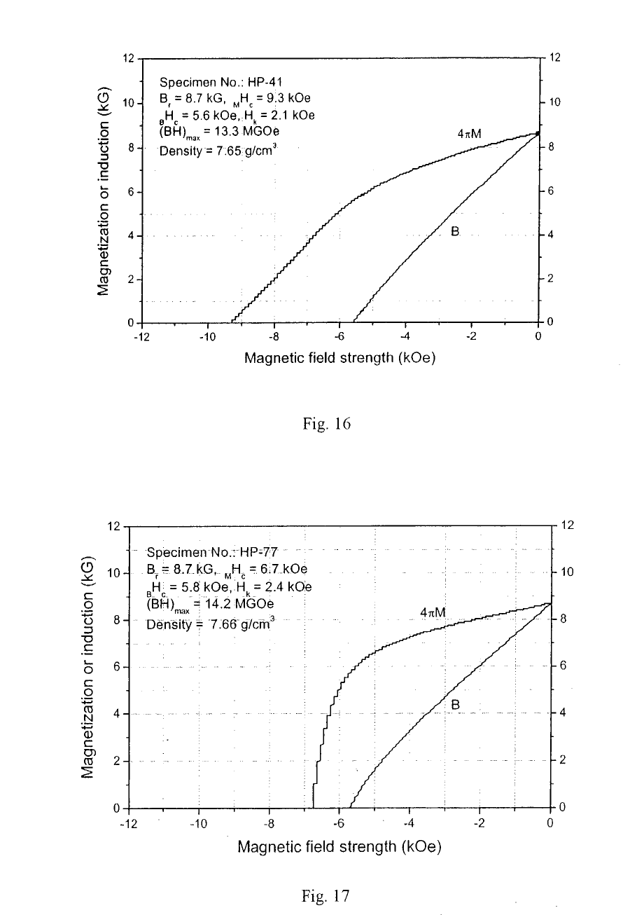

Referring to FIG. 16, demagnetization curves and magnetic properties of a hot-pressed bulk fully dense isotropic magnet specimen of Nd₈Pr_{1.4}Dy_{0.5}Fe_{78.3}Co_{5.9}Ga_{0.1}B_{5.8} are shown. This magnet was hot pressed at 700° C. with a pressure of 25 kpsi. The density of the magnets is 7.65 g/cm³. The total nominal rare earths content of this magnet is 9.9 at %. The metallic part of total rare earths content of the magnet is about 9.6 at %. The α-Fe content in the magnets is about 16 vol %.

### EXAMPLE 17

Referring to FIG. 17, demagnetization curves and magnetic properties of a hot-pressed bulk fully dense isotropic magnet specimen of Nd_{11.8}Fe_{77.2}Co_{5.5}B_{5.5} are shown. This magnet was hot pressed at 680° C. with a pressure of 25 kpsi. The density of the magnets is 7.66 g/cm³. The metallic part of total rare earths content of the magnet is about 11.5 at %. The α-Fe content in the magnets is about 2 vol %

### EXAMPLE 18

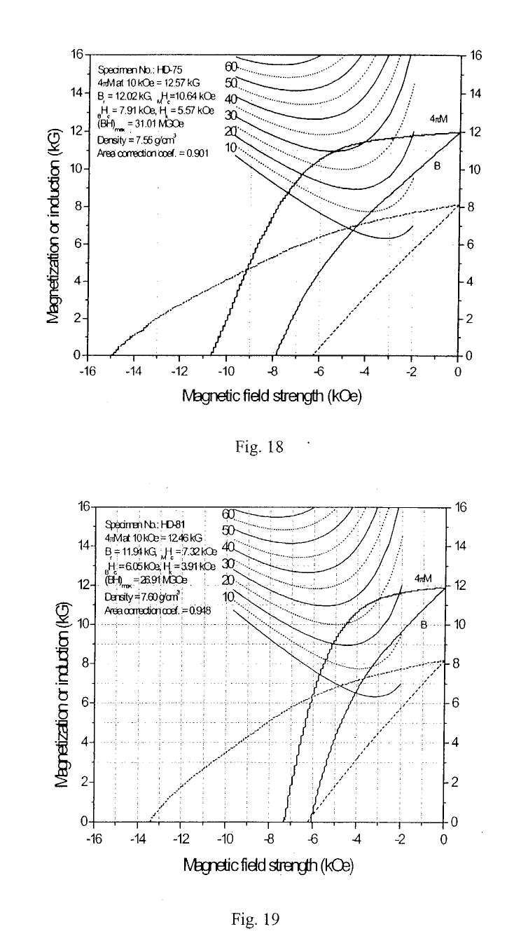

Referring to FIG. 18, the demagnetization curves of a hot pressed (dashed lines) and hot deformed (solid lines) magnet specimen of Nd_{10.7}Pr_{0.7}Dy_{0.2}Fe_{76.1}Co_{6.3}Ga_{0.4}B_{5.6} are shown. The hot pressed Nd_{10.7}Pr_{0.7}Dy_{0.2}Fe_{76.1}Co_{6.3}Ga_{0.4}B_{5.6} is an isotropic magnet having a remanence of around 8 kG and a maximum energy product of around 13 MGOe. The hot deformed Nd_{10.7}Pr_{0.7}Dy_{0.2}Fe_{76.1}Co_{6.3}Ga_{0.4}B₅₆ is an anisotropic magnet having a remanence of around 12 kG and a maxumum energy product of around 31 MGOe. The total rare earth content in this magnet is 11.6 at %. However, a small amount of the rare earth oxide formed during processing reduces the metallic part of the rare earth content to about 11.3 at %. The α-Fe content in this magnet is estimated to be about 4 vol %. This magnet was hot pressed at 650° C. with a pressure of 25 kpsi. The hot deformation was carried out at 760° C. with a pressure of 5 ksi. The height reduction during the deformation was 55%.

### EXAMPLE 19

Referring to FIG. 19, the demagnetization curves of hot pressed (dashed lines) and hot deformed (solid lines) nanocomposite Nd_{10.3}Pr_{0.8}DY_{0.3}B_{5.9}Co_{3.6}Fe_{79.1} are shown. The hot pressed Nd_{10.3}Pr_{0.8}Dy_{0.3}B_{5.9}Co_{3.6}Fe_{79.1} is an isotropic magnet having a remanence of around 8 kG and a maximum energy product of around 13 MGOe. The hot deformed Nd_{10.3}Pr_{0.8}Dy_{0.3}B_{5.9}Co_{3.6}Fe_{79.1} is an anisotropic magnet having a remanence of around 12 kG and a maximum energy product of 26.9 MGOe. The α-Fe content in the magnet is estimated to be about 5 vol %.

### EXAMPLE 20

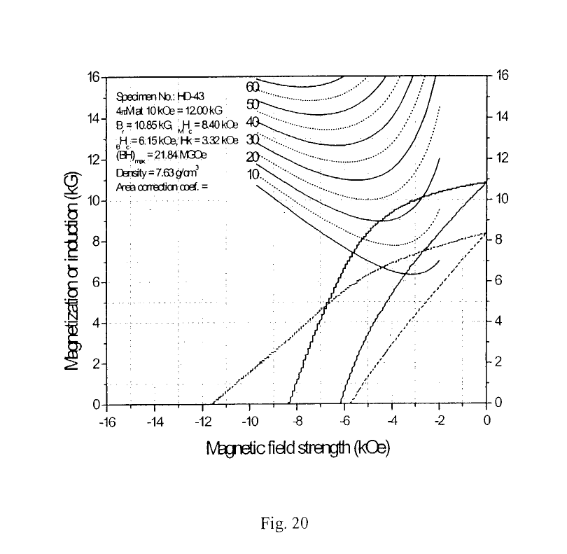

Referring to FIG. 20, demagnetization curves of hot pressed (dashed lines) and hot deformed (solid lines) nanocomposite Nd_{9.7}Pr₁Dy_{0.3}B_{5.7}Co_{6.1}Ga_{0.3}Fe_{76.9} are shown. The hot pressed Nd_{9.7}Pr₁Dy_{0.3}B_{5.7}Co_{6.1}Ga_{0.3}Fe_{76.9} is an isotropic magnet having a remanence of over 8 kG and a maximum energy product of around 13 MGOe. The hot deformed Nd_{9.7}Pr₁Dy_{0.3}B_{5.7}Co_{6.1}Ga_{0.3}Fe_{76.9} is an anisotropic magnet having a remanence of around 11 kG and a maximum energy product of around 22 MGOe. The α-Fe content in this magnet is about 8 at %.

### EXAMPLE 21

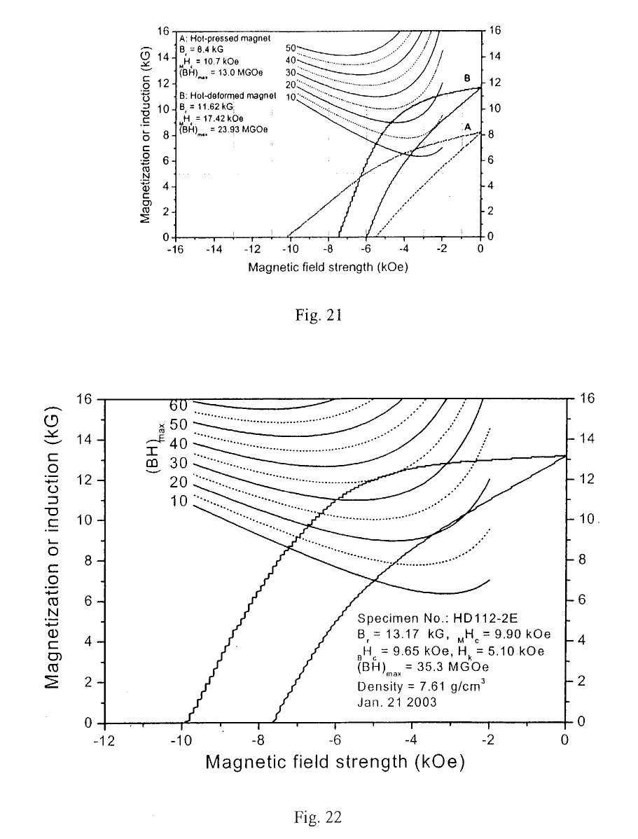

Referring to FIG. 21, demagnetization curves and magnetic properties of hot-pressed and hot-deformed magnet specimen of Nd_{9.2}Pr₁Dy_{0.3}Fe_{77.3}Co_{6.1}Al_{0.2}Ga_{0.2}B_{5.7} are shown. This magnet was hot pressed at 700° C. with a pressure of 25 kpsi. The hot deformation was carried out at 850° C. with a pressure of 5 ksi. The height reduction during the deformation was 39%. The metallic part of the rare earth content in this magnet is 10.2 at % and the α-Fe phase in the composite magnet specimen is about 11 vol %. At this level of α-Fe content, the maximum energy products obtained so far have been in the range of 20 to 25 MGOe. It should be noted that the relatively lower remanence of this deformed magnet is not because of its lower saturation magnetization, but because of its relatively poorer grain alignment.

### EXAMPLE 22

Referring to FIG. 22, demagnetization curves and magnetic properties of hot-pressed and hot-deformed magnet specimen of Nd_{10.8}Pr_{0.6}Dy_{0.2}Fe_{76.1}Co_{6.3}Ga_{0.2}Al_{0.2}B_{5.6} are shown. This magnet 670° C. with a pressure of 25 kpsi. The hot deformation was carried out at 820° C. with a pressure of 5 kpsi. The height reduction during the deformation was 60%. The maximum energy product of this magnet is 35.3 MGOe. The nominal total rare earth content of this magnet is 11.6 at %, while the metallic part of the rare earth content in this magnet is about 11.3 at %. The α-Fe phase in the composite magnet specimen is about 4 vol %. This magnet was prepared by blending two magnet alloy powders containing rare earths of 13 at % and 6 at %, respectively.

### EXAMPLE 23

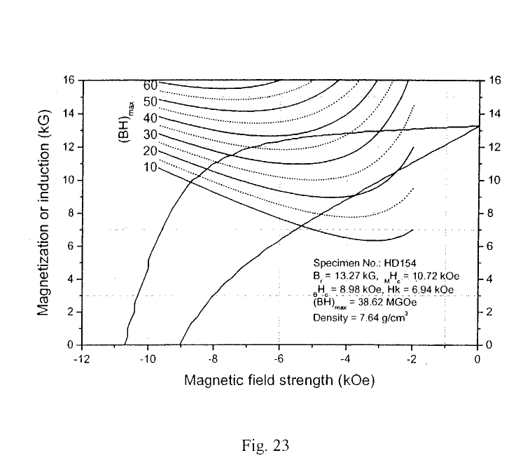

Referring to FIG. 23, the demagnetization curves and magnetic properties of hot-pressed and hot-deformed magnet specimen of Nd_{10.8}Pr_{0.6}Dy_{0.2}Fe_{76.1}Co_{6.3}Ga_{0.2}A_{10.2}B_{5.6} are shown. This magnet was hot pressed at 670° C. with a pressure of 25 kpsi. The hot deformation was carried out at 920° C. with a pressure of 3 kpsi. The height reduction during the deformation was 60%. The maximum energy product of this magnet is 38.6 MGOe. The metallic part of the rare earth content in this magnet is about 11.3 at % and the α-Fe phase in the composite magnet specimen is about 4 vol %. The nominal total rare earth content of this magnet is 11.6 at %. The magnet was prepared by blending two magnet alloys containing rare earths of 13 at % and 6 at %, respectively.

### EXAMPLE 24

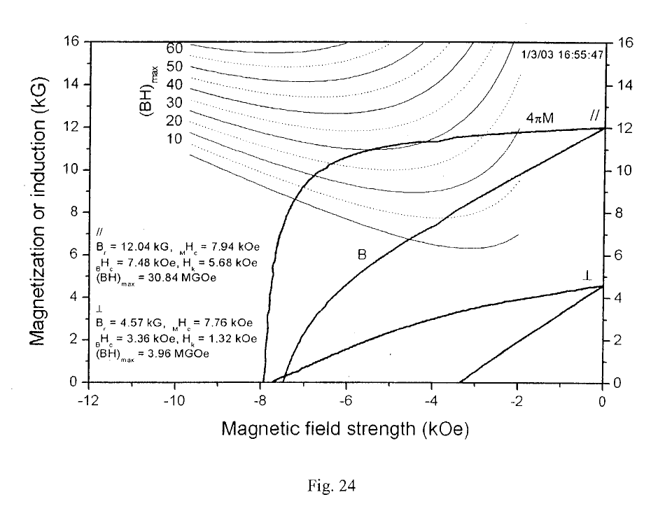

Referring to FIG. 24, the demagnetization curves characterized along the easy and difficult magnetization directions of an anisotropic magnet specimen of Nd_{10.5}Pr_{0.8}Dy_{0.3}Fe_{78.9}Co_{3.6}B_{5.9} are shown. Along these two different directions the remanences are 4.6 and 12 kG and the maximum energy products are 4 and 31 MGOe, respectively. The α-Fe phase in the composite magnet specimen is about 4 vol %.

### EXAMPLE 25

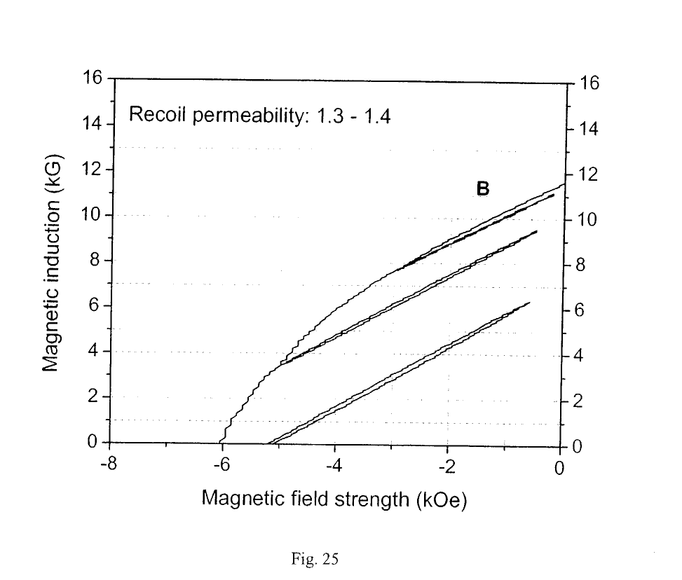

Referring to FIG. 25, the induction demagnetization curve and recoil permeability of hot-pressed and hot-deformed magnet specimen of Nd_{9.2}Pr₁Dy_{0.3}Fe_{77.3}Co₆Ga_{0.2}Al_{0.2}B_{5.7} are shown. The magnetic properties of this magnet is Bᵣ=11.6 kG, _{M}H_{c}=7.4 kOe, _{B}H_{c}=6.1 kOe, (BH)ₘₐₓ=24 MGOe. It can be seen from this figure that this nanocomposite magnet has a high recoil permeability of 1.3-1.4, much higher than that of conventional sintered Nd—Fe—B magnet which is 1.0 -1.05.

This magnet was hot pressed at 700° C. with a pressure of 25 kpsi. The hot deformation was carried out at 850° C. with a pressure of 5 kpsi. The height reduction during the deformation was 39%. The metallic part of the rare earth content in this magnet is 10.2 at % and the α-Fe phase in the composite magnet specimen is about 11 vol %.

### EXAMPLE 26

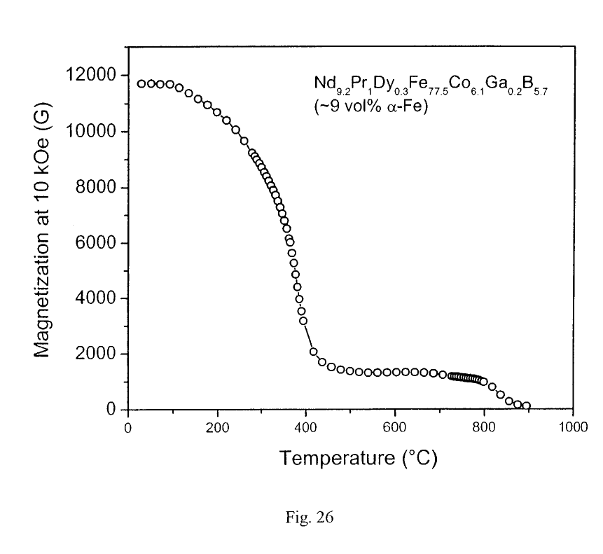

Referring to FIG. 26, the variation of magnetization at 10 kG vs. temperature of nanocomposite Nd_{9.2}Pr₁Dy_{0.3}Fe_{77.5}Co_{6.1}Ga_{0.2}B_{5.7} is shown. This magnet was hot pressed at 650° C. with a pressure of 25 kpsi. The hot deformation was carried out at 750° C. with a pressure of 5 kpsi. The height reduction during the deformation was 42%. The metallic part of the rare earth content in this magnet is 10.7 at % and the α-Fe phase in the composite magnet specimen is about 8 vol %. This figure clearly shows two distinguished Curie temperatures of this nanocomposite magnet: one Curie temperature of about 380° C. for the 2:14:1 phase, another Curie temperature of about 830° C. for the Fe-Co phase.

### EXAMPLE 27

Some nanocomposite magnets, especially those containing elements with high melting temperature such as Nb, Ti and those containing high B, are difficult to deform. Adding metals or alloys with low melting temperature can effectively facilitate the hot deformation and crystalline texture formation.

Table 6 summarizes the effect of some additives with low melting temperature on the hot deformation process. It can be seen from Table 6 that magnet alloys Nd_{11.1}Fe₈₁Nb_{1.4}B_{5.9} and Nd₄Fe₇₅B₂₁ are very difficult to deform. The Nd_{11.7}Fe₈₁Nb_{1.4}B_{5.9} magnet alloy was tried to be deformed at 880, 1000, and 1030° C., respectively, but no height reduction was observed. Similarly, magnet alloy Nd₄Fe₇₅B₂₁ was tried to be deformed at 760 and 1000° C., no height reduction was observed.

However, when some metals with low melting temperatures, such as Mg, Zn, Sn, In, and Bi, were added in to Nd_{11.7}Fe₈₁Nb_{1.4}B_{5.9} or Nd₄Fe₇₅B₂₁, hot deformation can be made with the height reduction with 10-60%. However, no effect was observed for Al.

TABLE 6
Effect of low melting temperature additives on hot deformation of
nanocomposite rare earth magnets.

| | | Hot | Hot | | |
|---|---|---|---|---|---|
| | | deformation | Deformation | Strain | |
| | | Temperature | Pressure | Rate | Height |
| Sample | Composition (at %) | (° C.) | (kpsi) | (sec⁻¹) | Reduction |
| HD-32 | Nd_{11.7}Fe₈₁Nb_{1.4}B_{5.9} | 880 | 17 | 0 | 0 |
| HD-56 | Nd_{11.7}Fe₈₁Nb_{1.4}B_{5.9} | 1030 | 11 | 0 | 0 |
| HD-62 | Nd₄Fe₇₅B₂₁ | 1000 | 17 | 0 | 0 |
| HD-63 | Nd_{11.7}Fe₈₁Nb_{1.4}B_{5.9} | 1000 | 17 | 0 | 0 |
| HD-86 | Nd₄Fe₇₅B₂₁ | 760 | 15 | 0 | 0 |
| HD106 | Nd₄Fe₇₅B₂₁ + | 880 | 9 | 1.3 × 10⁻⁴ | 30 |
| | 1.5 wt % Mg | | | | |
| HD123 | Nd_{11.7}Fe₈₁Nb_{1.4}B_{5.9} + | 840 | 15 | 0 | 0 |
| | 1.5 wt % Al | | | | |
| HD126 | Nd_{11.7}Fe₈₁Nb_{1.4}B_{5.9} + | 840 | 13 | 5.6 × 10⁻⁵ | 10 |
| | 1.5 wt % Mg | | | | |
| HD128 | Nd₄Fe₇₅B₂₁ + | 840 | 13 | 6 × 10⁻⁵ | 10 |
| | 1.5 wt % Zn | | | | |
| HD129 | Nd₄Fe₇₅B₂₁ + | 840 | 10 | 1 × 10⁻⁴ | 40 |
| | 1.5 wt % Sn | | | | |
| HD130 | Nd₄Fe₇₅B₂₁ + | 880 | 7 | 2 × 10⁻⁴ | 60 |
| | 1.5 wt % In | | | | |
| HD131 | Nd₄Fe₇₅B₂₁ + | 840 | 15 | 3.3 × 10⁻⁵ | 10 |
| | 1.5 wt % Bi | | | | |

### EXAMPLE 28

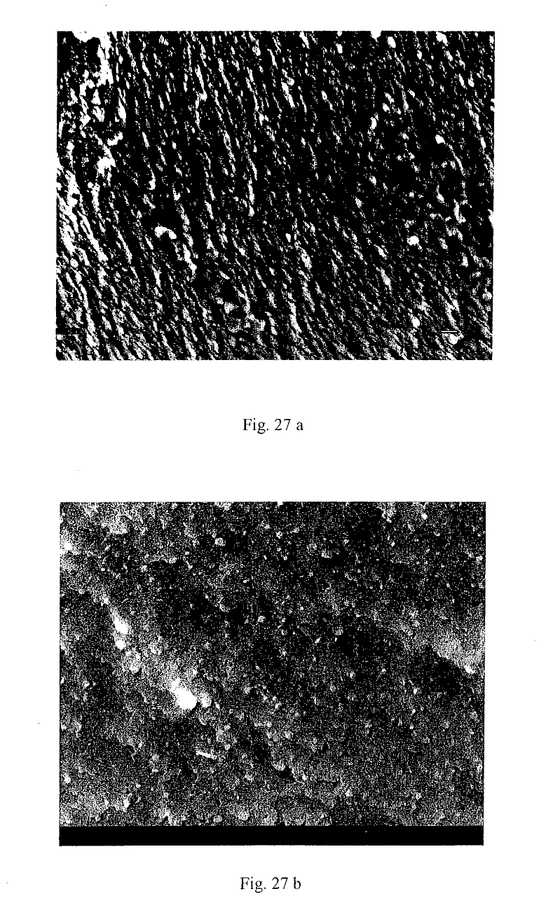

Referring to FIGS. 27a and 27b the fraction surface of hot-deformed Nd_{9.3}Pr₁Dy_{0.3}Fe_{77.4}Co_{6.1}Ga_{0.2}B_{5.7} is shown. The magnet was melt-spun and then hot-pressed at 650° C. The magnet was then hot-deformed at 750° C. FIG. 26a shows the surface with low magnification (scale bar: 1 micron) while FIG. 26b shows the surface with high magnification (scale bar: 100 nm). The surface is parallel to the stress direction during hot deformation.

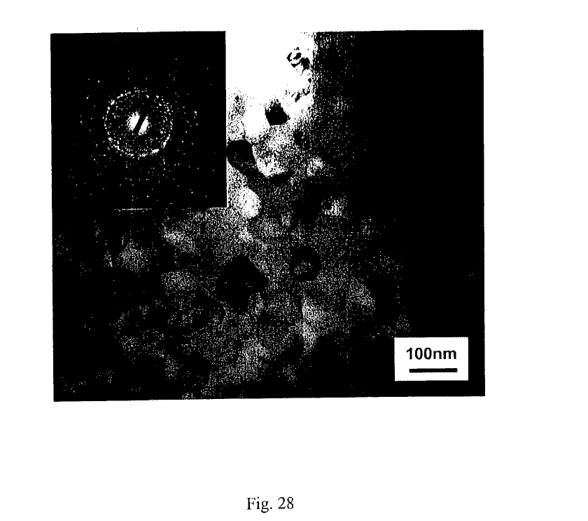

Referring to FIG. 28, a TEM image and a selected area electron diffraction pattern (shown as the insert) of the hot-deformed Nd_{9.3}Pr₁Dy_{0.3}Fe_{77.4}Co_{6.1}Ga_{0.2}B_{5.7} are shown. The electron diffraction pattern shows a 2:14:1 plus α-Fe phase structures. Grains with an average of about 50 nm are shown.

### Example 29

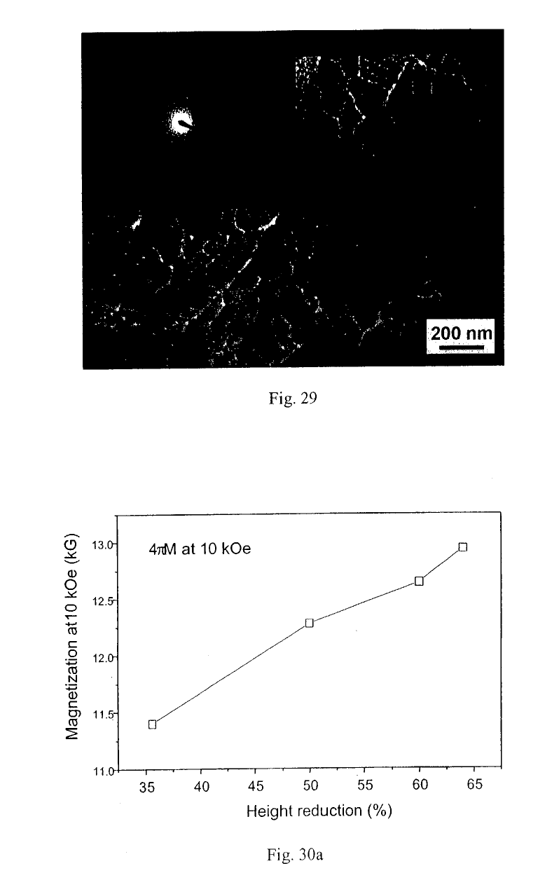

Referring to FIG. 29, a TEM image and a selected area electron diffraction pattern (shown as the insert) of a hot-pressed Nd_{2.4}Pr_{5.6}Dy₁Fe₈₅B₆ are shown. The alloy was melt-spun and then hot pressed at 930° C. for 3 minutes at a pressure of 20 kpsi. The grains are so small that TEM cannot identify individual grains. The electron diffraction pattern indicates very fine crystallites and amorphous phase.

### EXAMPLE 30

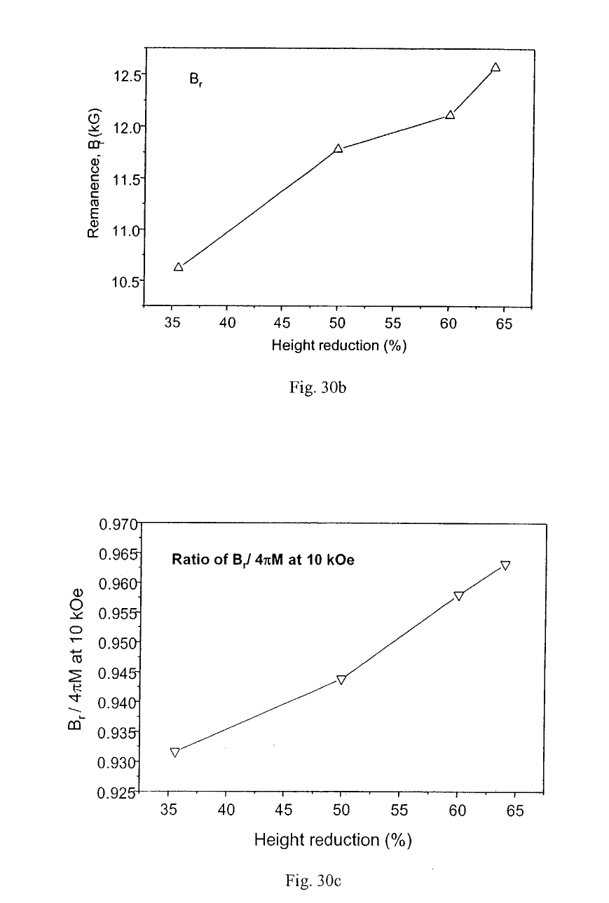

Referring to FIGS. 30a, 30b, and 30c effects of amount of hot deformation on 4πM at 10 kOe, remanence, Br, and ratio of Br over 4πM at 10 kOe of hot-pressed and hot-deformed magnet specimen of Nd_{10.4}Pr₁Dy_{0.3}Fe_{76.1}Co_{6.1}Ga_{0.2}A_{10.2}B_{5.7} are respectively. This magnet was hot pressed at 650° C. with a pressure of 25 kpsi. The hot deformation was carried out at 760° C. with pressures of 5-12 kpsi for different amount of hot deformation. The metallic part of the rare earth content in this magnet is 11.4 at % and the α-Fe phase in the composite magnet specimen is about 3 vol %. The nominal total rare earth content of this magnet is 11.7 at %.

Having described the invention in detail and by reference to preferred embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

What is claimed is:

1. A rare earth permanent magnet material having an average grain size between about 1 nm and about 400 nm comprising at least one rare-earth and at least one transition metal,
wherein said at least one rare-earth and said at least one transition metal form a rare earth-transition metal chemical compound,
wherein said at least one rare-earth is present in said magnet in an amount that is equal to or lower than the chemical stoichiometric amount of said rare-earth in said chemical compound,
wherein said magnet has full density,
wherein said magnet has a bulk structure selected from a bulk isotropic structure or a bulk anisotropic structure,
wherein said magnet is selected from a nanocrystalline rare earth magnet or a nanocomposite rare earth magnet.

2. A magnet material as claimed in claim 1, wherein said magnet material comprises a composition having a formula specified in atomic percentage as RₓT_{100-x-y-z}M_{y}L_{z} wherein R is selected from at least one rare earth material, yttrium, and combinations thereof, wherein T is selected from at least one transition metal and a combination of transition metals, wherein M is selected from at least one element in group IIIA, at least one element in group IVA, at least one element in group VA, and combinations thereof, wherein L is one or a mixture of metals or alloys having a melting temperature not higher than 950° C., wherein x is between about 2 to about 16.7, wherein y is between about 0 to about 20, and wherein z is between about 0 to about 16.

3. A magnet material as claimed in claim 1, wherein said magnet material comprises a composition having a formula specified in atomic percentage as RₓT_{100-x-y-z}M_{y}L_{z} wherein R is selected from at least one rare earth material, yttrium, and combinations thereof, wherein T is selected from at least one transition metal and a combination of transition metals, wherein M is selected from at least one element in group IIIA, at least one element in group IVA, at least one element in group VA, and combinations thereof, wherein L is one or a mixture of metals or alloys having a melting temperature not higher than 950° C., wherein x is between about 3 to about 16.7, wherein y is between about 0 to about 20, wherein z is between about 0 to about 16, wherein the amount of R present in said composition is no more than about 16.7 atomic percent.

4. A magnet material as claimed in claim 1, wherein said magnet material comprises a composition having a formula specified in atomic percentage as RₓT_{100-x-y-z}M_{y}L_{z} wherein R is selected from at least one rare earth material, yttrium, and combinations thereof, wherein T is selected from at least one transition metal and a combination of transition metals, wherein M is selected from at least one element in group IIIA, at least one element in group IVA, at least one element in group VA, and combinations thereof, wherein L is one or a mixture of metals or alloys having a melting temperature not higher than 950° C., wherein x is between about 3 to about 12.5, wherein y is between about 0 to about 20, wherein z is between about 0 to about 16, wherein the amount of R present in said composition is no more than about 12.5 atomic percent.

5. A magnet material as claimed in claim 1, wherein said magnet material comprises a composition having a formula specified in atomic percentage as RₓT_{100-x-y-z}M_{y}L_{z} wherein R is selected from at least one rare earth material, yttrium, and combinations thereof, wherein T is selected from at least one transition metal and a combination of transition metals, wherein M is selected from at least one element in group IIIA, at least one element in group IVA, at least one element in group VA, and combinations thereof, wherein L is one or a mixture of metals or alloys having a melting temperature not higher than 950° C., wherein x is between about 3 to about 10.5, wherein y is between about 0 to about 20, wherein z is between about 0 to about 16, wherein the amount of R present in said composition is no more than about 10.5 atomic percent.

6. A magnet material as claimed in claim 1, wherein said magnet material comprises a composition having a formula specified in atomic percentage as RₓT_{100-x-y-z}M_{y}L_{z} wherein R is selected from at least one rare earth material, yttrium, and combinations thereof, wherein T is selected from at least one transition metal and a combination of transition metals, wherein M is selected from at least one element in group IIIA, at least one element in group IVA, at least one element in group VA, and combinations thereof, wherein L is one or a mixture of metals or alloys having a melting temperature not higher than 950° C., wherein x is between about 2 to about 11.8, wherein y is between about 2 to about 25, wherein z is between about 0 to about 16, wherein the amount of R present in said composition is no more than about 11.8 atomic percent.

7. A magnet material as claimed in claim 1, wherein said chemical compound is selected from RT₅, RT₇, R₂T₁₇, and R₂T₁₄M.

8. A magnet material as claimed in claim 7, wherein said magnet material comprises an amount of R that is about equal to the chemical stoichiometric amount of R in a rare earth-transition metal compound.

9. A magnet material as claimed in claim 7, wherein said magnet material comprises an amount of R that is lower than the chemical stoichiometric amount of R in the rare earth-transition metal compound.

10. A magnet material as claimed in claim 9, wherein said magnet material further has a magnetically soft phase selected from Co, Fe—Co, and Fe₃B.

11. A magnet material as claimed in claim 1, wherein said rare earth is selected from Nd, Sm, Pr, Dy, La, Ce, Gd, Th, Ho, Er, Eu, Tm, Yb, misch metal, Y, and combinations thereof.

12. A magnet material as claimed in claim 1, wherein said transition metal is selected from Fe, Co, Ni, Ti, Zr, Hf. V, Nb, Ta, Cr, Mo, W, Mn, Cu, Zn, Cd, and combinations thereof.

13. A magnet material as claimed in claim 2, wherein said M is selected from B, Al, Ga, In, TI, C, Si, Ge, Sn, Sb, Bi, and combinations thereof.

14. A magnet material as claimed in claim 2, wherein said L is selected from Al, Mg, Zn, Ga, Se, Cd, In, Sn, Sb, Te, I, Ba, Tl, Bi, Al—Cu, Al—Ge, Al—In, Al—Mg, Al—Sn, Al—Zn, Bi—Mg, Bi—Mn, Ba—I, and combinations thereof.

15. A magnet material as claimed in claim 1, wherein said bulk structure is produced by a hot-press or similar process.

16. A magnet material as claimed in claim 1, wherein said bulk structure is produced by hot deformation or similar process.

17. A magnet material as claimed in claim 1, wherein said magnet material is anisotropic having a maximum magnetic energy product of at least 25 MGOe.

18. A magnet material as claimed in claim 1, wherein said magnet material is anisotropic having a maximum magnetic energy product between about 25 MGOe to about 90 MGOe.

19. A magnet material as claimed in claim 1, wherein said magnet material is isotropic having a maximum magnetic energy product between about 10 MGOe and about 20 MGOe.

20. A magnet material as claimed in claim 1, wherein said magnet material is isotropic having a maximum magnetic energy product of at least 10 MGOe.

21. A magnet material as claimed in claim 1, having an average grain size between about three nanometers to about 300 nanometers.

22. A magnet material as claimed in claim 1, wherein said magnet material is an isotropic nanocrystalline rare earth magnet.

23. A magnet material as claimed in claim 1, wherein said magnet material is an isotropic nanocomposite rare earth permanent magnet.

24. A magnet material as claimed in claim 1, wherein said magnet material is an anisotropic nanocrystalline rare earth magnet.

25. A magnet material as claimed in claim 1, wherein said magnet material is an anisotropic nanocomposite rare earth magnet.

26. A magnet material as claimed in claim 1, wherein said magnet material exhibits an intrinsic coercivity between about 5 kOe and about 20 kOe.

27. A magnet material as claimed in claim 1, wherein said magnet material exhibits an intrinsic coercivity between about 6 kOe and about 15 kOe.

28. A magnet material as claimed in claim 1, wherein said magnet material exhibits a remanence between about 7 kG and about 19 kG.

29. A magnet material as claimed in claim 1, wherein said magnet material exhibits a remanence between about 8 kG and about 17 kG.

30. A magnet material as claimed in claim 1, wherein said magnet material has a size between about 0.5 cm and about 15 cm.

31. A magnet material as claimed in claim 1, wherein said magnet material has a size between about 1 cm and about 6.0 cm.

32. A rare earth permanent magnet material having an average grain size between about 1 nm and about 400 nm comprising at least one rare-earth and at least one transition metal,
wherein said at least one rare-earth and said at least one transition metal form a rare earth-transition metal chemical compound,
wherein said at least one rare-earth is present in said magnet material in an amount that is equal to or lower than the chemical stoichiometric amount of said rare-earth in said chemical compound,
wherein said magnet material has an anisotropic structure, and
wherein said magnet material is selected from a nanocrystalline rare earth magnet powder or a nanocomposite rare earth magnet powder.

33. A magnet material as claimed in claim 32, wherein said magnet material comprises a composition having a formula specified in atomic percentage as RₓT_{100-x-y-z}M_{y}L_{z} wherein R is selected from at least one rare earth, yttrium, and combinations thereof, wherein T is selected from at least one transition metal and a combination of transition metals, wherein M is selected from at least one element in group IIIA, at least one element in group IVA, at least one element in group VA, and combinations thereof, wherein L is one or a mixture of metals or alloys having a melting temperature not higher than 950° C., wherein x is between about 2 to about 16.7, wherein y is between about 0 to about 20, and wherein z is between about 0 to about 16.

34. A magnet material as claimed in claim 32, wherein said magnet material comprises a composition having a formula specified in atomic percentage RₓT_{100-x-y-z}M_{y}L_{z} wherein R is selected from at least one rare earth, yttrium, and combinations thereof, wherein T is selected from at least one transition metal and a combination of transition metals, wherein M is selected from at least one element in group IIIA, at least one element in group IVA, at least one element in group VA, and combinations thereof, wherein L is one or a mixture of metals or alloys having a melting temperature not higher than 950° C., wherein x is between about 3 to about 12.5, wherein y is between about 0 to about 20, wherein z is between about 0 to about 16, wherein the amount of R present in said composition is no more than about 12.5 atomic percent.

35. A magnet material as claimed in claim 32, wherein said magnet material comprises a composition having a formula specified in atomic percentage as RₓT_{100-x-y-z}M_{y}L_{z} wherein R is selected from at least one rare earth, yttrium, and combinations thereof, wherein T is selected from at least one transition metal and a combination of transition metals, wherein M is selected from at least one element in group IIIA, at least one element in group IVA, at least one element in group VA, and combinations thereof, wherein L is one or a mixture of metals or alloys having a melting temperature not higher than 950° C., wherein x is between about 3 to about 10.5, wherein y is between about 0 to about 20, wherein z is between about 0 to about 16, wherein the amount of R present in said composition is no more than about 10.5 atomic percent.

36. A magnet material as claimed in claim 32, wherein said magnet material comprises a composition having a formula specified in atomic percentage as RₓT_{100-x-y-z}M_{y}L_{z} wherein R is selected from at least one rare earth, yttrium, and combinations thereof, wherein T is selected from at least one transition metal and a combination of transition metals, wherein M is selected from at least one element in group IIIA, at least one element in group IVA, at least one element in group VA, and combinations thereof, wherein L is one or a mixture of metals or alloys having a melting temperature not higher than 950° C., wherein x is between about 2 to about 11.8, wherein y is between about 2 to about 25, wherein z is between about 0 to about 16, wherein the amount of R present in said composition is no more than about 11.8 atomic percent.

37. A magnet material as claimed in claim 32, wherein said chemical compound is selected from RT₅, RT₇, R₂T₁₇, and R₂T₁₄M.

38. A magnet material as claimed in claim 37, wherein said magnet material comprises an amount of R that is about equal to the chemical stoichiometric amount of R in the chemical compound.

39. A magnet material as claimed in claim 37, wherein said magnet material comprises an amount of R that is lower than the chemical stoichiometric amount of R in the chemical compound.

40. A magnet material as claimed in claim 39, wherein said magnet material further has a magnetically soft phase selected from Co, Fe—Co, and Fe₃B.

41. A magnet material as claimed in claim 32, wherein said rare earth is selected from Nd, Sm, Pr, Dy, La, Ce, Gd, Tb, Ho, Er, Eu, Tm, Yb, misch metal, Y, and combinations thereof.

42. A magnet material as claimed in claim 32, wherein said transition metal is selected from Fe, Co, Ni, Ti, Zr, Hf. V, Nb, Ta, Cr, Mo, W, Mn, Cu, Zn, Cd, and combinations thereof.

43. A magnet material as claimed in claim 33, wherein said M is selected from B, Al, Ga, In, TI, C, Si, Ge, Sn, Sb, Bi, and combinations thereof.

44. A magnet material as claimed in claim 33, wherein said L is selected from Al, Mg, Zn, Ga, Se, Cd, In, Sn, Sb, Te, I, Ba, TI, Bi, Al—Cu, Al—Ge, Al—In, Al—Mg, Al—Sn, Al—Zn, Bi—Mg, Bi—Mn, Ba—I, and combinations thereof.

45. A magnet material as claimed in claim 32, having an average grain size between about three nanometers to about 300 nanometers.

46. A magnet material as claimed in claim 32, wherein said magnet material is an anisotropic nanocrystalline rare earth magnet powder.

47. A magnet material as claimed in claim 32, wherein said magnet material is an anisotropic nanocomposite rare earth magnet powder.

48. A magnet material as claimed in claim 32, wherein said magnet material contains a binder.

49. A magnet material as claimed in claim 48, wherein said binder is selected from epoxy, polyester, nylon, rubber, Sn, Zn, Al—Mg, Al—Sn, Al—Zn, and combinations thereof.

50. A magnet material as claimed in claim 32, wherein said magnet material has a maximum magnetic energy product of at least 25 MGOe.

51. A magnet material as claimed in claim 32, wherein said magnet material has a maximum magnetic energy product between about 25 MGOe to about 90 MGOe.

52. A magnet material as claimed in claim 32, wherein said magnet material has an average grain size between about three nanometers to about 300 nanometers.

53. A magnet material as claimed in claim 32, wherein said magnet material exhibits an intrinsic coercivity between about 5 kOe and about 20 kOe.

54. A magnet material as claimed in claim 32, wherein said magnet material exhibits an intrinsic coercivity between about 6 kOe and about 15 kOe.

55. A magnet material as claimed in claim 32, wherein said magnet material exhibits a remanence of at least 11 kG.

56. A method of fabricating a magnet comprising:
providing at least one rare earth-transition metal alloy having no rare-earth rich phase;
placing said at least one alloy in a powder form;
compacting said powder form of said at least one alloy to form compacts;
rapidly pressing said compacts using a heat source selected from DC, pulse DC, AC current, or eddy-current; and
forming a magnet material having a maximum magnetic energy product of at least 10 MGOe.

57. A method as claimed in claim 56, wherein said method further comprises mixing additive with said at least one alloy before placing said at least one alloy in said powder form.

58. A method as claimed in claim 56, wherein said method further comprises blending at least two alloy powders together before compacting said powder form.

59. A method as claimed in claim 56, wherein said method further comprises crystallizing said compacts using an elastic stress before rapidly pressing said compacts.

60. A method as claimed in claim 56, wherein said method further comprises subjecting said compact to a magnetic field before rapidly pressing said compacts.

61. A method as claimed in claim 56, wherein said method further comprises crushing said magnet material after said rapidly pressing said powder.

62. A method of fabricating a magnet comprising:
providing at least one rare earth-transition metal alloy having no rare-earth rich phase;
placing said at least one alloy in a powder form;
compacting said powder form of said at least one alloy to form compacts;
hot deforming said compacts using a pressure between about 2 kpsi and about 10 kpsi; and
forming a magnet having a magnetic energy product of at least 25 MGOe.

63. A method as claimed in claim 62, wherein said method further comprises crushing said magnet after said hot deforming said compacts to form a powder material.

64. A method as claimed in claim 63, wherein said method further comprises adding a binder to said powder material.
